(19) United States
(12) Patent Application Publication
(10) Pub. No.: US 2021/0279341 A1
(43) Pub. Date: Sep. 9, 2021

(54) CRYPTOGRAPHIC SECURITY SYSTEM, METHOD, AND PROGRAM PRODUCT USING DATA PARTITIONING

(71) Applicant: Timothy Arthur Huck, Richardson, TX (US)

(72) Inventor: Timothy Arthur Huck, Richardson, TX (US)

(21) Appl. No.: 17/071,937

(22) Filed: Oct. 15, 2020

Related U.S. Application Data
(63) Continuation-in-part of application No. 16/810,717, filed on Mar. 5, 2020.

(51) Int. Cl. G06F 21/60

(52) U.S. Cl. CPC G06F 21/602

(57) ABSTRACT

A method, system, and program product includes a data handler that receives data. A security controller retrieves an identifier that is used to determine a non-random pad and a representative cryptographic algorithm. A pad handler retrieves the non-random pad associated with the identifier. A conversion handler applies the representative cryptographic algorithm to the received data using the retrieved non-random pad to generate output data. Where the received data is raw data, the conversion handler encrypts the raw data by applying the representative algorithm to the non-random pad to produce a sequence of values that are distinct from the received data. Where the received data is encrypted data, the conversion handler decrypts the encrypted data by applying the non-random pad to the encrypted data to produce raw data.¿

### CROSS-REFERENCE TO RELATED APPLICATIONS

The present continuation patent application claims priority benefit of the U.S. nonprovisional patent application Ser. No. 16/810,717 entitled “A CRYPTOGRAPHIC SECURITY SYSTEM, METHOD, AND PROGRAM PRODUCT USING DATA PARTITIONING” filed 5 Mar. 2020. The contents of this related patent applications are incorporated herein by reference for all purposes to the extent that such subject matter is not inconsistent herewith or limiting hereof.

### INCORPORATION BY REFERENCE OF RELATED CO-PENDING U.S. PATENT APPLICATIONS

The contents of U.S. nonprovisional patent application Ser. No. 16/810,717, entitled “A CRYPTOGRAPHIC SECURITY SYSTEM, METHOD, AND PROGRAM PRODUCT USING DATA PARTITIONING”, filed 5 Mar. 2020 are incorporated herein by reference for all purposes to the extent that such subject matter is not inconsistent herewith or limiting hereof.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to data security using non-random pads and representative algorithms, in a configurable encryption/decryption system More particularly, certain embodiments of the invention permit for data from a file or stream to be encoded by repeatedly searching the non-random pad and recording the matches as a set of integer offsets, undirected graphs or vectors.

Representative cryptography uses a search algorithm and a non-random pad to create a set of data that corresponds to a representation of the original message in the non-random pad. The representational data can only be decrypted by applying the corresponding algorithm to the same non-random pad. This approach combines aspects of OTPs and Steganography while avoiding the limitations associated with both. Offset cryptography is presented as being an efficient example of a representative algorithm and show two other representative algorithms, graph and vector cryptography, that are mathematically related to offset cryptography, but produce different encrypted values.

Representative cryptography differs from steganography in that the media file is not used as a carrier for the message. In representative cryptography, the encrypted message is converted to a set of mathematical data by performing repeated searches on the non-random pad. The mathematical data is not appreciably larger than the original message and decryption is only possible with the matching non-random pad and corresponding algorithm. Steganography generally requires a large carrier file in order to avoid statistical analysis and other counter measures.

### BACKGROUND OF THE RELEVANT PRIOR ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Cryptography (also referred to as “cryptology”) refers to the practice and study of techniques for secure communication designed to avoid detection or comprehension by adversarial third parties. Cryptography constructs and analyzes rules and protocols that prevent or obstruct third parties or the unintended public from reading private messages. Modern cryptographic techniques exist at the intersection of communication and computer science and have been applied in electronic commerce, payment cards, digital currencies, computer passwords, and military communications, among other areas.

Within cryptography, key-based cryptography has emerged as the primary method for secure data storage, email, private messaging and network communications. There are currently two popular approaches using key-based encryption/decryption: (1) symmetric or “single-key” cryptography; and, (2) “public/private” or “dual-key” cryptography. Symmetric-key cryptography refers to encryption methods in which both the sender and receiver share the same key (or, less commonly, in which their keys are different, but related in an easily computable way). In contrast thereto, public-key cryptography, or asymmetric cryptography, is a key-based cryptographic system that uses pairs of keys: public keys which may be disseminated widely, and private keys which are known only to the owner. The generation of such keys depends on cryptographic algorithms based on mathematical problems to produce one-way functions. Effective security only requires keeping the private key private; the public key can be openly distributed without compromising security.

Security benefits offered by the implementation of advanced cryptographic techniques may be hampered due to current limitations and resulting difficulty of access even for a legitimate user, high general availability of the information sought to be protected via the cryptographic methods, challenges associated with selective access control, threats that emerge from the poor designs of systems, protocols and procedures, access to professional expertise and expense, as well as computational difficulties in implementing the cryptographic methods.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that data security systems exist that produce a steganographic selection key by using an encryption key as both the key and as the data to be encrypted. First an encryption key may be copied multiple times to form a data block which may be then encrypted using the same key. The resulting ciphertext may then be used as a selection key to select locations in a secondary data stream. These selected locations may then be modified with the original data to be encoded. Restoration of the original data may be accomplished by using the selection key to locate the modified areas of the data stream, extracting the data found there, and then decrypting the extracted data with the cypher text.

By way of educational background, another aspect of the prior art generally useful to be aware of include efforts related to encoding and decoding information into a stream of digitized samples in an integral manner. The information may be encoded using special keys. The information may be contained in the samples, not prepended or appended to the sample stream. The method makes it extremely difficult to find the information in the samples if the proper keys are not possessed by the decoder. The method does not cause a significant degradation to the sample stream. The method may be used to establish ownership of copyrighted digital multimedia content and provide a disincentive to piracy of such material.

Also, methods are known for transforming a secrecy outcome of a one-dimensional one-time pad (“OTP”) beyond existing limitations to a multi-dimensioned encryption system, achieving modern-day perfect secrecy over unlimited distances by using cryptographic-steganographic key-container files for securing and hiding communications.

Moreover, a reconfigurable and scalable cryptography (encryption/decryption) system architecture and related method are known. The system uses a multiple-pass approach, each pass applying one cryptography algorithm with its own cryptography keys. The encrypted data can only be fully and correctly decrypted with the correct algorithms in the correct sequence (as determined by one or more security level parameters) and the correct cryptography keys. The system includes a multiple cryptography algorithm set section which is reconfigurable to perform multiple cryptography algorithms sequentially, and a cryptography controller which receives an input key set and a security level parameter. The cryptography controller reconfigures the multiple cryptography algorithm set section based on the security level parameter to perform multiple selected cryptography algorithms in a selected sequence. The cryptography controller also generates cryptography keys based on the input key set and provide the cryptography keys to the multiple cryptography algorithm set section.

In view of the foregoing, it is clear that these traditional techniques may not be ideal for all situations and thus leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary flow diagram of a modular and configurable single-pass, representative cryptographic system in accordance with an embodiment of the present invention;

FIG. 2 illustrates an exemplary block diagram depicting a pad handler during encryption as, for example (but without limitation thereto), performed by and/or with a partitioning algorithm module in accordance with an embodiment of the present invention;

FIG. 3 illustrates an exemplary schematic of an offset representational algorithm module during encryption in accordance with an embodiment of the present invention;

FIG. 4 illustrates an exemplary an offset representational algorithm module during decryption in accordance with an embodiment of the present invention;

FIG. 5 illustrates an exemplary vector representational algorithm module during encryption;

FIG. 6 illustrates an exemplary flow diagram of a method for applying a set of rules having multiple media files and algorithms to encrypt and to decrypt data in discrete parts providing message secrecy, integrity and authenticity for communications and storage in accordance with an embodiment of the present invention;

FIG. 7 illustrates an exemplary flow diagram of a method for applying a set of rules having multiple media files and algorithms to generate non-random pads for later secure communications and storage in accordance with an embodiment of the present invention

FIG. 8 illustrates an exemplary block diagram denoting communication between a representational cryptographic service and a rule server associated therewith, both the representational cryptographic service and the rule server having multiple partitioning and representational algorithms and media files to generate one-time pads (“OTP”) and to encrypt and to decrypt data in discrete parts providing message secrecy, integrity and authenticity for communications and storage in accordance with an embodiment of the present invention;

FIG. 9 illustrates an exemplary flow diagram of a method for applying a representative algorithm to example media to encrypt and to decrypt data in discrete parts providing message secrecy, integrity and authenticity for communications and storage in accordance with an embodiment of the present invention, as well as an exemplary flow diagram of a method for creating a non-random pad using media files and a set of rules which can be used in secure communication and storage.;

FIG. 10 illustrates exemplary data primitive operations for rules including partitioning and assembly during pad creation, the rules including various algorithms, keys, pads and media, the data primitive operations including sizing, shaping, shuffling, rotating, flipping, splitting, joining and reversing the data in accordance with an embodiment of the present invention;

FIG. 11 illustrates an exemplary block diagram depicting an example client/server system that may be used by an example web-enabled/networked embodiment of the present invention; and

FIG. 12 illustrates an exemplary block diagram depicting an example client/server communication system that may be used for a cryptographic security system using non-random pads and configurable representational based encryption and/or decryption in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [” substantially“] as connoting a term of approximation or a term of magnitude”). Here, when referring to the “substantially halfway” limitation, the Specification uses the word “approximately” as a substitute for the word “substantially”. The ordinary meaning of “substantially halfway” is thus reasonably close to or nearly at the midpoint between the forwardmost point of the upper or outsole and the rearward most point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicant submits that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicant hereby gives notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

### Definitions

Reference to “Active Directory” implies a directory service that Microsoft (ID developed for the Windows® domain networks.

Reference to “algorithm” implies a set of instructions, typically solve a class of problems or perform a computation. Algorithms are unambiguous specifications for performing calculation, data processing, automated reasoning, and other tasks.

Reference to “authentication”, in cryptography, implies a message authentication code (MAC), sometimes known as a tag, is a short piece of information used to authenticate a message—in other words, to confirm that the message came from the stated sender (its authenticity) and has not been changed. The MAC value protects both a message's data integrity as well as its authenticity, by allowing verifiers (who also possess the secret key) to detect any changes to the message content.

Reference to “certificate”, in a cryptography context, implies a file which contains either a public key or public/private key pair.

Reference to “cipher” implies algorithm for performing encryption or decryption—a series of well-defined steps that can be followed as a procedure. An alternative, less common term is encipherment. To encipher or encode is to convert information into cipher or code. In common parlance, “cipher” is synonymous with “code”, as they are both a set of steps that encrypt a message; however, the concepts are distinct in cryptography, especially classical cryptography. Codes generally substitute different length strings of character in the output, while ciphers generally substitute the same number of characters as are input. There are exceptions and some cipher systems may use slightly more, or fewer, characters when output versus the number that were input. The operation of a cipher usually depends on a piece of auxiliary information, called a key (or “cryptovariable”). The encrypting procedure is varied depending on the key, which changes the detailed operation of the algorithm. A key must be selected before using a cipher to encrypt a message. Without knowledge of the key, it should be extremely difficult, if not impossible, to decrypt the resulting ciphertext into readable plaintext.

Reference to “cloud” implies the model of computer data storage in which the digital data is stored in logical pools. The physical storage spans multiple servers (sometimes in multiple locations), and the physical environment is typically owned and managed by a hosting company. These cloud storage providers are responsible for keeping the data available and accessible, and the physical environment protected and running. People and organizations buy or lease storage capacity from the providers to store user, organization, or application data. Cloud storage services may be accessed through a co-located cloud computing service, a web service application programming interface (API) or by applications that utilize the API, such as cloud desktop storage, a cloud storage gateway or Web-based content management systems.

Reference to “confidentiality” implies the concept of ensuring that data is not made available or disclosed to unauthorized people. Confidentially is achieved through encryption. Both symmetric and asymmetric encryption can be used. Confidentiality may have been the original purpose of cryptography. If the data is confidential, it cannot be read or understood by anyone other than the intended recipient or recipients. [Source: http://securitycerts.org/review/cryptography-confidentiality.htm; Retrieved on: 06-12-19].

Reference to “cryptography” or “cryptology” implies the practice and study of techniques for secure communication in the presence of third parties called adversaries. [Source: Rivest, Ronald L. (1990). “Cryptography”. In J. Van Leeuwen (ed.). Handbook of Theoretical Computer Science]. More generally, cryptography is about constructing and analyzing protocols that prevent third parties or the public from reading private messages; [source: Bellare, Mihir; Rogaway, Phillip (21 Sep. 2005). “Introduction”. Introduction to Modern Cryptography. p. 10.] various aspects in information security such as data confidentiality, data integrity, authentication, and non-repudiation [source: Menezes, A. J.; van Oorschot, P. C.; Vanstone, S. A. (1997). Handbook of Applied Cryptography. ISBN 978-0-8493-8523-0. Archived from the original on 7 Mar. 2005] are central to modern cryptography. Modern cryptography exists at the intersection of the disciplines of mathematics, computer science, electrical engineering, communication science, and physics. Applications of cryptography include electronic commerce, chip-based payment cards, digital currencies, computer passwords, and military communications. Modern cryptography is heavily based on mathematical theory and computer science practice; cryptographic algorithms are designed around computational hardness assumptions, making such algorithms hard to break in practice by any adversary.

Reference to “data” implies a set of values of subjects with respect to qualitative or quantitative variables. In a cryptography context, “data” implies a set of bytes, usually stored in volatile memory and obtained from storage, networks or other streams. Data has a starting byte and ending byte and the order of the bytes in between is integral to the information contained.

Reference to “data integrity” implies the maintenance of, and the assurance of the accuracy and consistency of, data over its entire life-cycle, [source: Boritz, J. “IS Practitioners’ Views on Core Concepts of Information Integrity”. International Journal of Accounting Information Systems. Elsevier. Archived from the original on 5 Oct. 2011. Retrieved 12 Aug. 2011] and is a critical aspect to the design, implementation and usage of any system which stores, processes, or retrieves data. The term is broad in scope and may have widely different meanings depending on the specific context—even under the same general umbrella of computing. It is at times used as a proxy term for data quality, [source: https://www.veracode.com/blog/2012/05/what-is-data-integrity; retrieved on: 06-13-19] while data validation is a pre-requisite for data integrity. [Source: https://digitalguardian.com/blog/what-data-integrity-data-protection-101; retrieved on: 06-12-19] Data integrity is the opposite of data corruption. [M. G. Michael; “Uberveillance and the Social Implications of Microchip Implants: Emerging Technologies] The overall intent of any data integrity technique is the same: ensure data is recorded exactly as intended (such as a database correctly rejecting mutually exclusive possibilities) and upon later retrieval, ensure the data is the same as it was when it was originally recorded. In short, data integrity aims to prevent unintentional changes to information. Data integrity is not to be confused with data security, the discipline of protecting data from unauthorized parties. Any unintended changes to data as the result of a storage, retrieval or processing operation, including malicious intent, unexpected hardware failure, and human error, is failure of data integrity. If the changes are the result of unauthorized access, it may also be a failure of data security. Depending on the data involved this could manifest itself as benign as a single pixel in an image appearing a different color than was originally recorded, to the loss of vacation pictures or a business-critical database, to even catastrophic loss of human life in a life-critical system.

Reference to “data partition handler” implies a reusable transformation logic independent of a specific transport protocol.

Reference to “data partitioning” implies a division of a logical database or its constituent elements into distinct independent parts. Database partitioning is normally done for manageability, performance or availability reasons, or for load balancing.

Reference to “decryption” implies a process in which encrypted data is converted into its original (digital or electronic) form using, for example (but without limitation thereto) a protect or correct key.

Reference to “Diffie-Hellman key exchange” implies a method of securely exchanging cryptographic keys over a public channel. The Diffie-Hellman key exchange method allows two parties that have no prior knowledge of each other to jointly establish a shared secret key over an insecure channel. This key can then be used to encrypt subsequent communications using a symmetric key cipher.

Reference to “DNSSec” refers to Domain Name System Security Extensions (DNSSEC), which is a suite of Internet Engineering Task Force (IETF) specifications for securing certain kinds of information provided by the Domain Name System (DNS) as used on Internet Protocol (IP) networks. It is a set of extensions to DNS which provide to DNS clients (resolvers) origin authentication of DNS data, authenticated denial of existence, and data integrity, but not availability or confidentiality.

Reference to “encryption” implies a process of encoding a message or information in such a way that only authorized parties can access it and those who are not authorized cannot. Encryption does not itself prevent interference, but denies the intelligible content to a would-be interceptor. In an encryption scheme, the intended information or message, referred to as plaintext, is encrypted using an encryption algorithm—a cipher—generating ciphertext that can be read only if decrypted. For technical reasons, an encryption scheme usually uses a pseudo-random encryption key generated by an algorithm. It is in principle possible to decrypt the message without possessing the key, but, for a well-designed encryption scheme, considerable computational resources and skills are required. An authorized recipient can easily decrypt the message with the key provided by the originator to recipients but not to unauthorized users.

Reference to “key”, in cryptography, implies a piece of information (a parameter) that determines the functional output of a cryptographic algorithm. For encryption algorithms, a key specifies the transformation of plaintext into ciphertext, and vice versa for decryption algorithms. Keys also specify transformations in other cryptographic algorithms, such as digital signature schemes and message authentication codes.

Reference to “key exchange” refers to an algorithm that allows for the creation of a session key as used in symmetric key cryptography.

Reference to “key management” implies the management of cryptographic keys in a cryptosystem. This includes dealing with the generation, exchange, storage, use, crypto-shredding (destruction) and replacement of keys. It includes cryptographic protocol design, key servers, user procedures, and other relevant protocols. [Source: Turner, Dawn M. “What Is Key Management? A CISO Perspective”; Cryptomathic; Retrieved on: 05-30-2016].

Reference to “key store” refers to a secure file that contains keys used for key based cryptography.

Reference to “modular programming” implies a software design technique that emphasizes separating the functionality of a program into independent, interchangeable modules, such that each contains everything necessary to execute only one aspect of the desired functionality. A module interface expresses the elements that are provided and required by the module. The elements defined in the interface are detectable by other modules. The implementation contains the working code that corresponds to the elements declared in the interface. Modular programming is closely related to structured programming and object-oriented programming, all having the same goal of facilitating construction of large software programs and systems by decomposition into smaller pieces, and all originating around the 1960s. While the historical usage of these terms has been inconsistent, “modular programming” now refers to high-level decomposition of the code of an entire program into pieces: structured programming to the low-level code use of structured control flow, and object-oriented programming to the data use of objects, a kind of data structure.

Reference to “module” implies a discrete piece of code which can be independently created and maintained to be used in different systems.

Reference to “network” implies a digital telecommunications network which allows nodes to share resources. In computer networks, computing devices exchange data with each other using connections (data links) between nodes. These data links are established over cable media such as wires or optic cables, or wireless media such as Wi-Fi. Network computer devices that originate, route and terminate the data are called network nodes. Nodes are generally identified by network addresses, and can include hosts such as personal computers, phones, and servers, as well as networking hardware such as routers and switches. Two such devices can be said to be networked together when one device is able to exchange information with the other device, whether or not they have a direct connection to each other. In most cases, application-specific communications protocols are layered (i.e. carried as payload) over other more general communications protocols. This formidable collection of information technology requires skilled network management to keep it all running reliably.

Reference to “network host” implies a computer connected to a computer network. A host may work as a server offering information resources, services, and applications to users or other nodes on the network. Hosts are assigned at least one network address. A computer participating in networks that use the Internet protocol suite may also be called an IP host. Specifically, computers participating in the Internet are called Internet hosts, sometimes Internet nodes. Internet hosts and other IP hosts have one or more IP addresses assigned to their network interfaces. The addresses are configured either manually by an administrator, automatically at startup by means of the Dynamic Host Configuration Protocol (DHCP), or by stateless address autoconfiguration methods. Network hosts that participate in applications that use the client-server model of computing, are classified as server or client systems. Network hosts may also function as nodes in peer-to-peer applications, in which all nodes share and consume resources in an equipotent manner.

Reference to “non-repudiation” implies “the assurance that someone cannot deny the validity of something. Non-repudiation is a legal concept that is widely used in information security and refers to a service, which provides proof of the origin of data and the integrity of the data. In other words, non-repudiation makes it very difficult to successfully deny who/where a message came from as well as the authenticity of that message. Digital signatures (combined with other measures) can offer non-repudiation when it comes to online transactions, where it is crucial to ensure that a party to a contract or a communication can't deny the authenticity of their signature on a document or sending the communication in the first place. In this context, non-repudiation refers to the ability to ensure that a party to a contract or a communication must accept the authenticity of their signature on a document or the sending of a message.” [Source: https://www.cryptomathic.com/products/authentication-signing/digital-signatures-faqs/what-is-non-repudiation; Retrieved on: 06-13-19].

Reference to “one-time-pad” implies an encryption technique that cannot be cracked, but requires the use of a one-time pre-shared key the same size as, or longer than, the message being sent. In this technique, a plaintext is paired with a random secret key (also referred to as a one-time pad). Then, each bit or character of the plaintext is encrypted by combining it with the corresponding bit or character from the pad using modular addition. If the key is (1) truly random, (2) at least as long as the plaintext, (3) never reused in whole or in part, and (4) kept completely secret, then the resulting ciphertext will be impossible to decrypt or break. [Source: “Intro to Numbers Stations”; Archived from the original on 18 Oct. 2014; Retrieved on: 9-13-14; One-Time Pad (OTP)”; Cryptomuseum.com. Archived from the original on 2014-03-14. Retrieved on 03-17-14]. It has also been proven that any cipher with the perfect secrecy property must use keys with effectively the same requirements as OTP keys. [Source: Shannon, Claude (1949). “Communication Theory of Secrecy Systems”. Bell System Technical Journal. 28 (4): 656-715.] Digital versions of one-time pad ciphers have been used by nations for some critical diplomatic and military communication, but the problems of secure key distribution have made them impractical for most applications.

Reference to “partitioning algorithm” implies an algorithm that accepts data and creates multiple distinct data subsets.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Reference to “public-key cryptography” implies a cryptographic system that uses pairs of keys: public keys which may be disseminated widely, and private keys which are known only to the owner. The generation of such keys depends on cryptographic algorithms based on mathematical problems to produce one-way functions. Effective security only requires keeping the private key private; the public key can be openly distributed without compromising security. [Source: Stallings, William (3 May 1990). Cryptography and Network Security: Principles and Practice. Prentice Hall. p. 165.]

Reference to “raw data” implies data that has been processed by the present invention for decryption or data that is being processed by the present invention for encryption.

Reference to “steganography” is the practice of concealing a file, message, image, or video within another file, message, image, or video. Steganography includes the concealment of information within computer files. In digital steganography, electronic communications may include steganographic coding inside of a transport layer, such as a document file, image file, program or protocol. Media files are ideal for steganographic transmission because of their large size. For example, a sender might start with an innocuous image file and adjust the color of every hundredth pixel to correspond to a letter in the alphabet. The change is so subtle that someone who is not specifically looking for it is unlikely to notice the change.

Reference to “symmetric-key cryptography” implies algorithms for cryptography that use the same cryptographic keys for both encryption of plaintext and decryption of ciphertext. The keys may be identical or there may be a simple transformation to go between the two keys. [Source: Kartit, Zaid (February 2016). “Applying Encryption Algorithms for Data Security in Cloud Storage, Kartit, et al”. Advances in ubiquitous networking: proceedings of UNet15: 147.] The keys, in practice, represent a shared secret between two or more parties that can be used to maintain a private information link. [Source: Delfs, Hans & Knebl, Helmut (2007). “Symmetric-key encryption”. Introduction to cryptography: principles and applications.] This requirement that both parties have access to the secret key is one of the main drawbacks of symmetric key encryption, in comparison to public-key encryption (also known as asymmetric key encryption). [Source: Mullen, Gary & Mummert, Carl (2007). Finite fields and applications. American Mathematical Society. p. 112; “Demystifying symmetric and asymmetric methods of encryption”. Cheap SSL Shop. 2017-09-28.]

Reference to a guided-user-interface (“GUI”) implies a form of user interface that allows users to interact with electronic devices through graphical icons and visual indicators such as secondary notation, instead of text-based user interfaces, typed command labels or text navigation.

Reference to representational state transfer (REST) implies a software architectural style that defines a set of constraints to be used for creating Web services. Web services that conform to the REST architectural style, called RESTful Web services (RWS), provide interoperability between computer systems on the Internet. RESTful Web services allow the requesting systems to access and manipulate textual representations of Web resources by using a uniform and predefined set of stateless operations. Other kinds of Web services, such as SOAP Web services, expose their own arbitrary sets of operations. [Source: “Web Services Architecture”. World Wide Web Consortium. 11 Feb. 2004. 3.1.3 Relationship to the World Wide Web and REST Architectures. Retrieved 29 Sep. 2016.

Reference to a command-line interface or a command-language interpreter (“CLI”)), also known as command-line user interface, console user interface [source: “Text mode programs (CUI: Console User Interface)”; Wine User Guide.; Retrieved 22 Sep. 2013] and character user interface (CUI), is a means of interacting with a computer program where the user (or client) issues commands to the program in the form of successive lines of text (command lines). A program which handles the interface is called a command language interpreter or shell.

Reference to Rivest-Shamir-Adleman (“RSA”) implies one of the first public-key cryptosystems and is widely used for secure data transmission. In such a cryptosystem, the encryption key is public and it is different from the decryption key which is kept secret (private). In RSA, this asymmetry is based on the practical difficulty of the factorization of the product of two large prime numbers, the “factoring problem”.

Reference to the Advanced Encryption Standard (“AES”), also known by its original Dutch language-origin name “Rijndael”, is a specification for the encryption of electronic data established by the U.S. National Institute of Standards and Technology (NIST) in 2001. [Source: “Announcing the ADVANCED ENCRYPTION STANDARD (AES)” (PDF); Federal Information Processing Standards Publication 197; United States National Institute of Standards and Technology (NIST); Nov. 26, 2001; Archived (PDF) from the original on Mar. 12, 2017; Retrieved Oct. 2, 2012.] AES is based on a design principle known as a substitution—permutation network, and is efficient in both software and hardware. [Source: Bruce Schneier; John Kelsey; Doug Whiting; David Wagner; Chris Hall; Niels Ferguson; Tadayoshi Kohno; et al. (May 2000). “The Twofish Team's Final Comments on AES Selection” (PDF). Archived (PDF) from the original on 2010-01-02.]

Reference to, in cryptography, an substitution-permutation network (also referred to as an “SP-network” or “SPN””, implies a series of linked mathematical operations used in block cipher algorithms such as (but not limited to): AES (Rijndael), 3-Way, Kalyna, Kuznyechik, PRESENT, SAFER, SHARK, and Square. Such a network takes a block of the plaintext and the key as inputs, and applies several alternating “rounds” or “layers” of substitution boxes (S-boxes) and permutation boxes (P-boxes) to produce the ciphertext block. The S-boxes and P-boxes transform (sub-)blocks of input bits into output bits. It is common for these transformations to be operations that are efficient to perform in hardware, such as exclusive or (XOR) and bitwise rotation. The key is introduced in each round, usually in the form of “round keys” derived from it. (In some designs, the S-boxes themselves depend on the key.) Decryption is done by simply reversing the process (using the inverses of the S-boxes and P-boxes and applying the round keys in reversed order).

Reference to, in cryptography, “twofish” and/or “2-Fish”, implies a symmetric key block cipher with a block size of 128 bits and key sizes up to 256 bits. It was one of the five finalists of the Advanced Encryption Standard contest, but it was not selected for standardization. Twofish is related to the earlier block cipher Blowfish. Twofish's distinctive features are the use of pre-computed key-dependent S-boxes, and a relatively complex key schedule. One half of an n-bit key is used as the actual encryption key and the other half of the n-bit key is used to modify the encryption algorithm (key-dependent S-boxes). Twofish borrows some elements from other designs; for example, the pseudo-Hadamard transform (PHT) from the SAFER family of ciphers. Twofish has a Feistel structure like DES. Twofish also employs a Maximum Distance Separable matrix.

Reference to the Data Encryption Standard (“DES”), in cryptography, implies a symmetric-key algorithm for the encryption of electronic data. Although its short key length of 56 bits, criticized from the beginning, makes it too insecure for most current applications, it was highly influential in the advancement of modern cryptography. DES is the archetypal block cipher—an algorithm that takes a fixed-length string of plaintext bits and transforms it through a series of complicated operations into another ciphertext bitstring of the same length. In the case of DES, the block size is 64 bits. DES also uses a key to customize the transformation, so that decryption can supposedly only be performed by those who know the particular key used to encrypt. The key ostensibly consists of 64 bits; however, only 56 of these are actually used by the algorithm. Eight bits are used solely for checking parity, and are thereafter discarded. Hence the effective key length is 56 bits.

Reference to “graph theory”, in mathematics, implies the study of graphs, which are mathematical structures used to model pairwise relations between objects. A graph in this context is made up of vertices (also called nodes or points) which are connected by edges (also called links or lines). A distinction is made between undirected graphs, where edges link two vertices symmetrically, and directed graphs, where edges link two vertices asymmetrically; see Graph (discrete mathematics) for more detailed definitions and for other variations in the types of graph that are commonly considered. Graphs are one of the prime objects of study in discrete mathematics. In computer science, graphs are used to represent networks of communication, data organization, computational devices, the flow of computation, etc. For instance, the link structure of a website can be represented by a directed graph, in which the vertices represent web pages and directed edges represent links from one page to another. A similar approach can be taken to problems in social media, [source: Grandjean, Martin (2016). “A social network analysis of Twitter: Mapping the digital humanities community”. Cogent Arts & Humanities. 3 (1): 1171458] travel, biology, computer chip design, mapping the progression of neuro-degenerative diseases, [source: Vecchio, F (2017). ““Small World” architecture in brain connectivity and hippocampal volume in Alzheimer's disease: a study via graph theory from EEG data”. Brain imaging and behavior. 11 (2): 473-485; Vecchio, F (2013). “Brain network connectivity assessed using graph theory in frontotemporal dementia”. Neurology. 81 (2): 134-143.] and many other fields. The development of algorithms to handle graphs is therefore of major interest in computer science. The transformation of graphs is often formalized and represented by graph rewrite systems. Complementary to graph transformation systems focusing on rule-based in-memory manipulation of graphs are graph databases geared towards transaction-safe, persistent storing and querying of graph-structured data.

Reference to a “Caesar cipher” or “shift cipher”, in cryptography, implies a type of the offset cryptography where each letter in the plaintext is replaced by a letter some fixed number of positions down the alphabet. For example, with a left shift of 3, “D” would be replaced by “A”, “E” would become “B”, and so on.

Reference to “ROT13”, e.g., “rotate by 13 places”, sometimes hyphenated ROT-13, implies a simple letter substitution cipher that replaces a letter with the 13th letter after it, in the alphabet. ROT13 is a special case of the Caesar cipher which was developed in ancient Rome.

Reference to an “XOR” operation, also referred to as an “exclusive or” or “exclusive disjunction” implies a logical operation that outputs true only when inputs differ (one is true, the other is false). [Source: Germundsson, Roger; Weisstein, Eric. “XOR”; MathWorld; Wolfram Research; Retrieved 17 Jun. 2015.] It gains the name “exclusive or” because the meaning of “or” is ambiguous when both operands are true; the exclusive or operator excludes that case. This is sometimes thought of as “one or the other but not both”. This could be written as “A or B, but not, A and B”. More generally, XOR is true only when an odd number of inputs are true. A chain of XORs—a XOR b XOR c XOR d (and so on)—is true whenever an odd number of the inputs are true and is false whenever an even number of inputs are true.

Reference to “primitive data type”, in computer science, implies either of the following: a basic type is a data type provided by a programming language as a basic building block. Most languages allow more complicated composite types to be recursively constructed starting from basic types. a built-in type is a data type for which the programming language provides built-in support. In most programming languages, all basic data types are built-in. In addition, many languages also provide a set of composite data types. Opinions vary as to whether a built-in type that is composite should be considered “primitive”. Depending on the language and its implementation, primitive data types may or may not have a one-to-one correspondence with objects in the computer's memory. However, one usually expects operations on basic primitive data types to be the fastest language constructs there are. Integer addition, for example, can be performed as a single machine instruction, and some processors offer specific instructions to process sequences of characters with a single instruction. In particular, the C standard mentions that “a ‘plain’ int object has the natural size suggested by the architecture of the execution environment”. This means that int is likely to be 32 bits long on a 32-bit architecture. Basic primitive types are almost always value types.

Reference to a message authentication code (“MAC”), sometimes known as a tag, in cryptography, implies a short piece of information used to authenticate a message—in other words, to confirm that the message came from the stated sender (its authenticity) and has not been changed. The MAC value protects both a message's data integrity as well as its authenticity, by allowing verifiers (who also possess the secret key) to detect any changes to the message content. Informally, a message authentication code consists of three algorithms: (1) a key generation algorithm selects a key from the key space uniformly at random; (2) a signing algorithm efficiently returns a tag given the key and the message; (3) a verifying algorithm efficiently verifies the authenticity of the message given the key and the tag. That is, return accepted when the message and tag are not tampered with or forged, and otherwise return rejected. For a secure unforgeable message authentication code, it should be computationally infeasible to compute a valid tag of the given message without knowledge of the key, even if for the worst case, we assume the adversary can forge the tag of any message except the given one.

Reference to a “single-pass” data processing scheme, in cryptography, may imply that an algorithm is constructed for the processing of an arbitrary length plaintext, left-to-right, spitting out the corresponding bits of ciphertext, again left to right, as you go, while only using constant memory. [Source:

https://crypto. stackexchange.com/questions/32702/difference-between-single-pass-and-two-pass-macs; Retrieved on: 06-21-19].

Reference to a “two-pass” data processing scheme, in cryptography, may imply two constant-memory left-to-right passes through plaintext, and so on and so forth.

[Source: https://crypto.stackexchange.com/questions/32702/difference-between-single-pass-and-two-pass-macs; Retrieved on: 06-21-19].

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### Terminology

The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache.” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of example-related language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128s or 256-bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the web sites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, those skilled in the art will readily recognize, in view of the teachings of the disclosed embodiments, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself is transitory.

### INTRODUCTION

Modern cryptography deals with the securing of digital data referring, generally, to the design of mechanisms based on mathematical algorithms that provide fundamental information security services, e.g., establishing a large database of resources containing various techniques for security applications. [Source: https://www.tutorialspoint.com/cryptography/modern_cryptography.htm; Retrieved on: 06-14-19]. Cryptography seeks to provide the following services: (1) confidentiality; (2) data integrity; (3) authentication; and, (4) non-repudiation. In a cryptography-related context, confidentiality refers to retention of confidential information from an unauthorized person or third party. Data integrity refers to handling the identification of any alterations to encrypted data; which may be altered either intentionally or by accident. Data integrity evaluation services confirm whether inspected data is intact or not since its most recent creation, transmission, or storage by an authorized user. Authentication refers to the provision of the identification of the data originator. Authentication confirms to the receiver that received data has in fact been sent only be an identified and verified sender. And, non-repudiation refers to a security services that ensures an entity cannot refused the ownership of a previous commitment or an action as assured by the original creator of the data, who cannot deny its creation or transmission to a recipient or third party. [Source: https://www.tutorialspoint.com/cryptography/modern_cryptography.htm; Retrieved on: 06-14-19].

Advances in modern cryptography have resulted in proportionate increased demands on databases, such that the division of databases into their logical or constituent elements through a process known as data or database partitioning is done for data manageability, performance, availability or for load balancing. Thus, integrating partitioning methods and functionality into cryptographic applications can introduce data processing performance enhancements. Relying on key-based cryptography for data security, inclusive of configurable encryption and decryption systems using data partitioning and the application of multiple keys and key-based algorithms, can greatly benefit or otherwise improve upon methods for secure data storage, email, private messaging and network communications.

### General Description of the Disclosed Embodiments

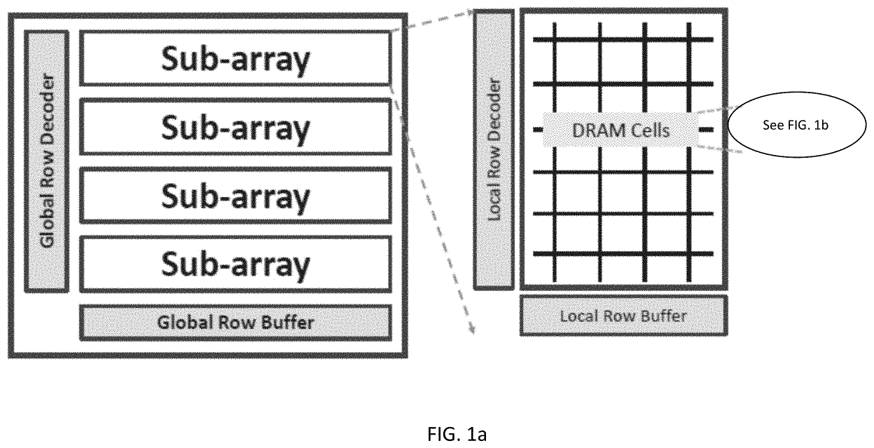

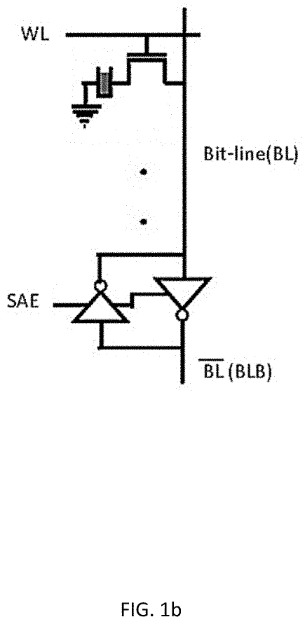

The disclosed embodiments, e.g., as reflected in that shown in FIGS. 1-5 and described in connection therewith, feature a modular and configurable data encoding handler as well as a modular and configurable non-random pad handler, both of which interact with each other to at least provide an encryption and decryption system and method. The disclosed embodiments provide methods for creating non-random pads using, for example (but without limitation thereto) any digital media or combinations of digital media, and identifies methods of representative encoding algorithms, and/or other computational forms and/or transformations that converts raw data and at least one non-random pad into a set of offsets, graphs or vectors that not only completely hide the original data but also minimize undesirable data inflation. Lastly, the disclosed embodiments at least provide a method of retrieving raw data from the representative encodings and the non-random pads.

In an embodiment, the non-random pad is used to produce a sequence of data that is distinct from original data. The non-random pad is composed of a media file or files and may be considered analogous to a “carrier” file as referred to and used in steganography applications; however, here, the non-random pad is left intact and does not transmit itself (or any part thereof) during secure communication. Likewise, the presently disclosed embodiments are distinct from traditional random one-time pads (“OTPs”) in that the non-random pads are used with a representational algorithm, to replace traditional ciphering.

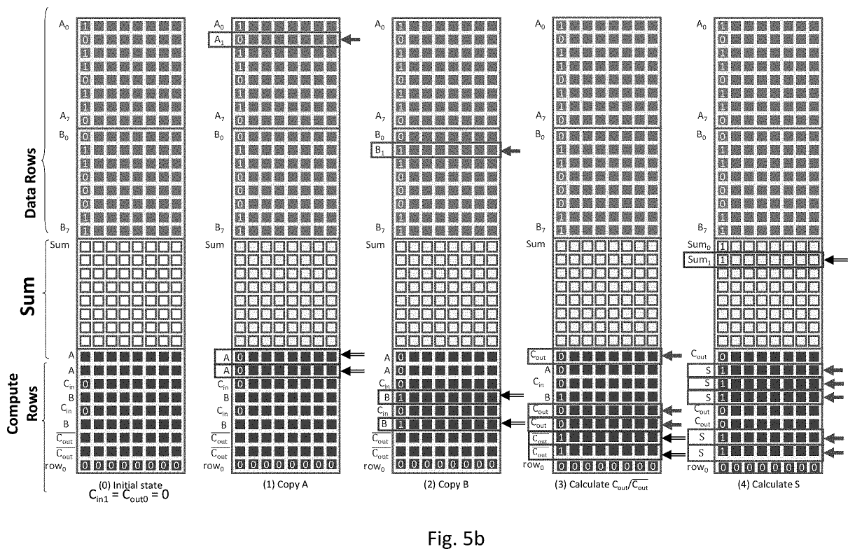

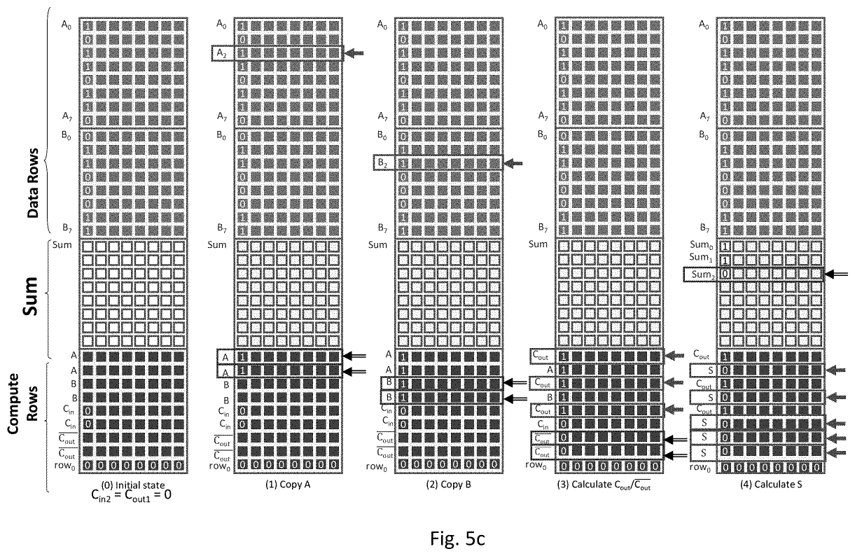

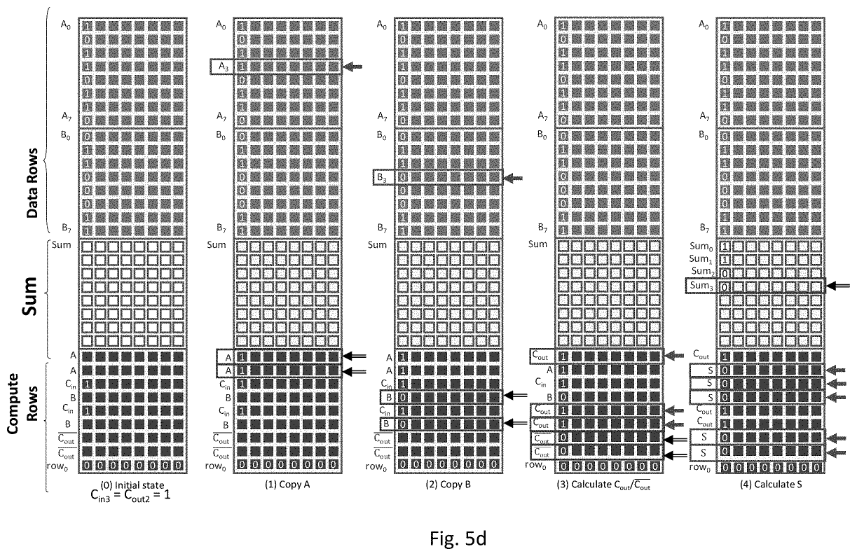

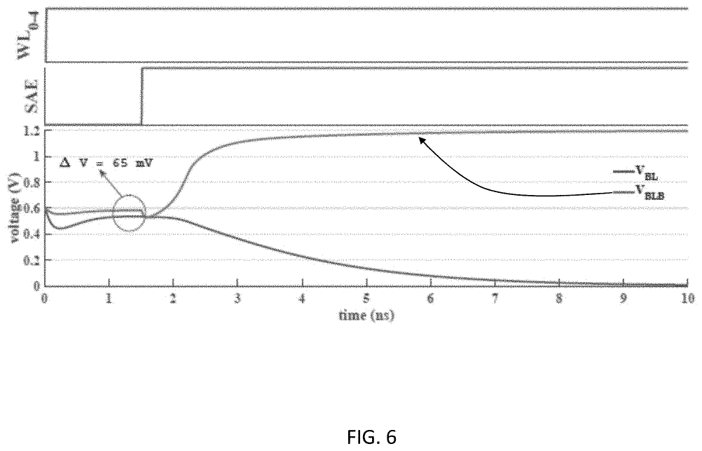

A true OTP consists of random data, which is difficult to produce and difficult to prove is truly random. A non-random pad can be a private media file, a public media file, an executable file from a known version of software (ex. Java 1.6.012, Word 2012 build 0214), or a combination of two or more binary files, all of which are not random, merely secret. An OTP should be destroyed upon use and once all copies of the OTP are destroyed, the OTP can not be recreated (or it is not random). A non-random pad can be obtained or generated independently by communicating parties. Also a non-random pad can be obtained or generated from public and private sources, used for encryption and then destroyed for safe storage or transit. When decryption is desired, the non-random pad can again be obtained or generated from the same sources. Pad generation is as much a factor in this system as the binary files that are the sources for the non-random pads. As shown in FIG. 6, the rules used during encryption, decryption and pad creation can change independently of the pad used, increasing reuse and security. The non-random pad is used to replace ciphering and are not transmitted. The non-random pad is composed of a media file or files and is thus not random, but merely secret.

A true OTP consists of random data, which is difficult to produce and difficult to prove is truly random. A non-random pad can be a private media file, a public media file, an executable file from a known version of software (ex. Java 1.6.012, Word 2012 build 0214), or a combination of two or more binary files, all of which are not random, merely secret. An OTP should be destroyed upon use and once all copies of the OTP are destroyed, the OTP can not be recreated (or it is not random).

Any one or more of the presently disclosed embodiments, and/or any combination thereof, collectively or individually, provide a cryptographic security system, program product and/or method of use thereof for processor-based computing systems including (but not limited thereto): personal computers, cell phones, tablets, virtual and/or cloud based environments, the Internet of Things (“IoT”) and/or network devices. It is a further object of the invention to provide encryption and/or decryption of digital data in a file and/or stream between multiple independent systems. Another object of the invention is to allow automatic and/or manual configuration to provide complete flexibility for human and/or non-human (e.g., computer-based) users of the system.

In an embodiment, a cryptographic system and/or method of use thereof is disclosed, the system and/or method including (by way of example and not limitation): (a) inputting of the data to be encrypted, (b) receiving identifiers for a non-random pad and representative algorithm to be used, (c) retrieving or creating the non-random pad, (d) encoding the data using the representative algorithm and non-random pad, (e) storing or sending the encoded data.

In an embodiment, a cryptographic system and/or method of use thereof is disclosed, the system and/or method including (by way of example and not limitation): (a) input of the data to be decrypted, (b) receiving identifiers for the non-random pad and representative algorithm to be used, (c) retrieving or creating the non-random pad, (d) decoding the data using the representative algorithm and non-random pad, (e) storing or viewing the decoded data.

### System Structure

Generally referring to the various systems, methods of use thereof, modules and/or operations shown in FIGS. 1-5 collectively, in one or more embodiments, a set of pad creation algorithms and a set of representational algorithms configurable to perform data transformation operations, e.g., encryption and decryption operations, in a single pass on raw and encrypted data are shown. Encryption of raw data may be performed by applying a representational algorithm to a non-random pad to create a set of values that may be at least sequence equivalent values in the non-random pad. Corresponding decryption of data encrypted by usage of the non-random pad may be performed by applying the sequence equivalent values to the non-random pad to retrieve the corresponding equivalent values of the raw data. In one or more embodiments, an offset may be applied to the non-random pad prior to initiation of encryption and decryption operations. A security controller may receive a list of pad creation and representational algorithms and accepts identifiers, offsets and data sources to use as a configuration to control encryption and decryption operations. Configuration information may be configured by a second system and destroyed on the host after being used for encryption. Decryption may be performed by either: (1) retrieving the configuration from the second system; or, (2) sending the encrypted data to the second system. An XOR type operation, e.g., “one or the other but not both”, may be applied using a non-random pad, similar to one-time pad usage. OTPs are difficult to produce, difficult to transport and can only be used once (thus the name). The raw binary files used to create a non-random pad could include a specific version of software, a video uploaded to youTube or shared via SnapChat, an audio file on a streaming service or media that was recorded and shared only between the communicating parites. The communicating parties can build a library of media files both online and locally sourced that can be used to create an infinite number of pads.

In one or more embodiments shown and discussed in connection with FIGS. 1-5, a system may encode data using a representative format based on the values contained in a non-random pad. A representative algorithm performs the operation of encoding and decoding data by converting the values in the data to values in the non-random pad. Such encoded data can only be decoded correctly by applying the representative format and algorithm to the non-random pad that was used during the encoding process. A non-random pad, by way of example and not limitation, can be any binary file or combination of binary files, including local and web-based videos or streams. The non-random pad may never be altered and only the encoded data is stored or sent over a network.

Disclosed embodiments use a multi-step process of, for example (and not limitation thereto): (1) acquiring data; (2) determining a non-random pad to be used; and, (3) applying the representative algorithm to the data using the non-random pad. Determining the non-random pad to be used may include acquiring and processing media files to create the pad, or the pad may have been generated previously. Encoded data may be composed of values that determine a way to recreate raw data using values in the non-random pad; and, may be of a similar size to the raw data. By way of example and not limitation, one or more embodiments provide a security controller that allows for receiving, storing and retrieving the configuration of non-random pads and representational algorithms, and provides a pad handler to acquire, store and create non-random pads. A conversion handler may be provided that stores and applies modular representation algorithm modules.

FIG. 1 illustrates an exemplary flow diagram of a modular and configurable single-pass, representative cryptographic system in accordance with an embodiment of the present invention. In the present embodiment, a cryptographic system 100 may include various handlers, inclusive of a data handler 104, a pad handler 106, and a conversion handler 108, any one more in functional communication with a security controller 116. Further, in one or more embodiments, representative algorithm and pad identifiers 114 may be passed to the security controller 116 for subsequent passing to any one or more of the data handler 104, pad handler 106, and conversion handler 108 for application therewith. Moreover, by way of example and not limitation, non-random pads 110 and representative algorithm modules 112 may be passed to the pad handler 106 and the conversion handler 108 to transform incoming raw or encoded data 102 supplied to the data handler to output encoded or raw data 118. Those skilled in the art will appreciate that any one or more of the handlers and/or modules shown in the cryptographic system 100 may integrate, combine with, and/or replace any one or more of the handlers and/or modules shown in the cryptographic system 100 of FIG. 1 for the purposes of data transformation, e.g., encryption and/or decryption.

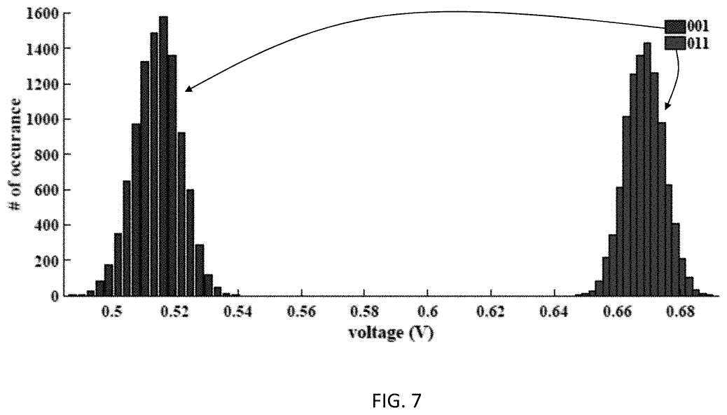

More particularly, FIG. 1 illustrates the cryptographic system 100, which may be both configurable and modular, and shows raw data 102 being input into the cryptographic system 100 by the data handler 104, which may receive information related to a data source and/or type of operation being performed from the security controller 116. In one or more embodiments, the data handler 104 may function at least substantially similar to the data handler 102 shown and described earlier in connection with FIG. 1, e.g., by providing and/or employing a reusable transformation logic, which can be used by exports and imports to transform native formats into business data and from business data into native formats as may be required by external services. [Source: https://www.ibm.com/support/knowledgecenter/en/SS8JB4/com.ibm.wbpm.main.doc/top ics/esbprog bindings datahandler.html; Retrieved on: 06-24-19]. By way of example and not limitation, raw data may be acquired by the data handler 104 from any source such as (but not limited to): a local file system, a local network, a virtual network, Wi-Fi, cellular, USB, Bluetooth or another form of digital communication. The data hander 104 and/or the cryptographic system 100 more generally may be configured to receive and/or handle any type of data such as (but not limited to): plain text, formatted, compiled, encoded, compressed or encrypted. Accordingly, upon receipt of incoming raw data 102, the data handler 104 may compute the size thereof in bytes and may also apply simple transforms to the data such as (but not limited thereto): (1) byte encoding; or, (2) padding. Representative cryptography could be modularized and provide encryption and decryption services for a partition. For example, a pad handler 106 may be combined with other cryptographic components, such a partition handler (not shown). FIGS. 6-7 do show an integrated pad handler and representational cryptography handler.

As shown in FIG. 1 the data handler 104 passes the acquired raw data 102 and information regarding the size thereof to the pad handler 106, which, in one or more embodiments, may also receive the pad or algorithm to be used from the security controller 116. Non-random pads, e.g., referring to matrixes having a define length and width being populated by characters, such as letters selected not at random, the letters being suitable for navigation therewith upon supply of a key regarding transforming unencoded raw data (a message) to encoded data (ciphertext), may be created by the pad handler 106 from one or more local or web based media files and a non-random pad creation module. The pad handler 106 may include multiple pad creation modules (not shown in FIG. 1), any one or more of which include the rules to process media file or files. Non-random pads, in one or more embodiments, may be created during operations or retrieved from a secure pad store.

Processing, by the pad handler 106, of the media file or files may include multiple rules, e.g., applied sequentially, in parallel, or in any other order and/or configuration. Such media files may be provided in multiple formats; however, any one or more of the multiple formats may include media files that are composed of non-contiguous blocks of binary data constrained by formatted headers, control blocks and/or padding. In one or more embodiments, specific rules used to extract the binary data may impact encoding and decoding performed by the conversion handler 108.

By way of example and not limitation, there may be several ways to extract binary blocks from a media file and to combine the binary blocks together. Control blocks may be removed from the media file completely, leaving only the binary blocks. Redundant bytes may be compacted together so that the control blocks are reduced in size and/or quantity. Control blocks may, also, be combined with binary data using, for example (and not limitation thereto), an XOR operation. Resulting blocks of binary data may be further combined and/or integrated using multiple data primitive operations such as shuffling, rotating and reordering. Likewise, using multiple media files may involve multiple extractions of binary data that may need to be combined in a specific and/or pre-defined manner.

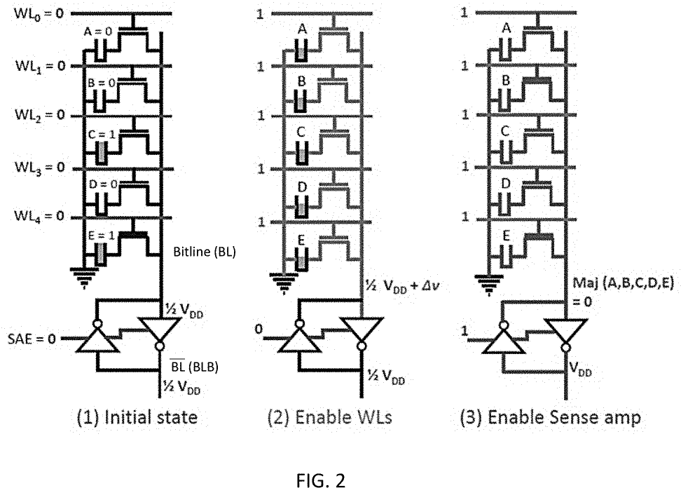

FIG. 2 illustrates an exemplary block diagram depicting a pad handler during either encryption or decryption as, for example (but without limitation thereto), performed by and/or with a partitioning algorithm module in accordance with an embodiment of the present invention. In the present embodiment, a pad handling system 200 includes a pad handler 202 that includes various operations and/or modules 206-216 responsible for the transformation of one or more media files to a non-random pad. Operationally, an algorithm and media identifiers 204 and/or content and/or functionality associated with and/or provided by local storage or the Internet 208 may be passed to an acquire media file or files operation 206, where such media file or files may then be passed, by the pad handler 202, to a manipulation operation 210 that includes each of: (1) a remove control blocks operation 212; followed by a (2) merge binary data operation 214.

Data stored in or otherwise associated with the media file or files acquired in the acquire media file or files operation 206 may have control blocks removed therefrom in the remove control blocks operation 212 and have binary data associated therewith merged in the merge binary data operation to be passed to a use or store pad operation 216 to produce a non-random pad 220 suitable for subsequent passage to, for example (and not limitation thereto), the pad handler 106 shown and discussed in connection with FIG. 1.

More particularly, by way of example and not limitation, pad handler 202 during pad creation, e.g., of non-random pad 220, is shown in FIG. 2. Media files may be acquired after the algorithm and media identifiers may be received at the acquire media file or files operation 206. A media identifier may be a path to a local or network file or a URL to a web-based resource. The media files may then be passed to the manipulation operation 210 where control blocks are processed at the remove control blocks operation 212 and the binary blocks are assembled at binary data operation 214. After creation of the non-random pad 220, one or more identifiers 218 may be passed back to a security controller, e.g., security controller 116 shown in FIG. 1, and the non-random pad 120 pad may be passed to the conversion handler.

In one or more embodiments, the pad handling system 200 may include a method to generate a non-random pad creation module that accepts media files and applies a set of rules to produce a non-random pad. Producing a custom non-random pad creation module may increase security since pad creation may be or otherwise involve a compounding factor such that the number of ways to create a pad may be very large and also increase with the number of media files and rules. Moreover, by way of example and not limitation, pad creation modules may be added, removed and modified by the pad handling system 200.

In an embodiment, the security controller 116, shown in FIG. 1, may pass a non-random pad and data to be encoded to and/or from the pad handler 106 as well as an identifier from, for example the representative algorithm and pad identifiers 114, to the conversion handler 108, which may contain multiple modules that perform representational encoding. A representational algorithmic module may take the data and a non-random pad to produce a series of encoding data.

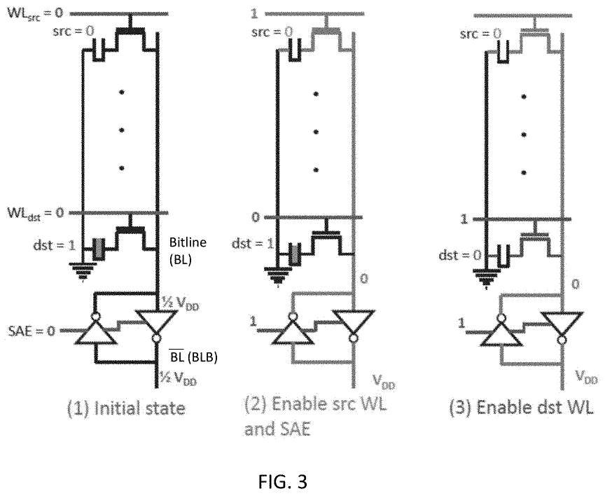

FIG. 3 illustrates an exemplary schematic of an offset representational algorithm module during encryption in accordance with an embodiment of the present invention. In the present embodiment, a non-random pad-based encryption process 300 may involve the encryption of a message 302. By way of example and not limitation, the message 302 may be paired with a non-random pad 304, which, in an embodiment, may be at least substantially generated by the pad handling system 200 of FIG. 2. Each character and/or letter of the message 302, here as shown “ABCDEFG”, may be located in the non-random pad 304 in an offset encoding operation 308 by one or more offset distances 310 calculate or otherwise determine one or more individual offset quantities 312, which may later be aggregated by the non-random pad-based encryption process 300 to produce encoded message 314. A true OTP consists of random data, which is difficult to produce and difficult to prove. A non-random pad can be a private media file, a public media file, an executable file from a known version of software (e.g., Java 1.6.012, Word 2012 build 0214), or a combination of two or more binary files, all of which are not random, merely secret. An OTP should be destroyed upon use and once all copies of the OTP are destroyed, the OTP can not be recreated (or it is not random). A non-random pad can be obtained or generated independently by communicating parties. Also a non-random pad can be obtained or generated from public and private sources, used for encryption and then destroyed for safe storage or transit. When decryption is desired, the non-random pad can again be obtained or generated from the same sources. Pad generation is as much a factor in this system as the binary files that are the source for the non-random pad.

More particularly, by way of example and not limitation, as illustrated in FIG. 3, offset encoding 308 may be considered to be a type and/or form of a representational algorithm which receives, as input therein, data from message 302 to be encoded and non-random pad 304 and to produce a series of individual offset quantities 312 from the non-random pad 304 that can be used to recreate original data, e.g., message 302. The offset encoding module 308 may search, e.g., from an initial byte (shown as letter “K”) in the non-random pad 304 (by an electronic communication route 306), for a byte that matches the first byte, e.g., “A”, of the data to be encoded from message 302. The first offset quantity or value, e.g., “7”, is the number of bytes traversed in the non-random pad 304 before finding a matching byte. The position of the first matching byte may then then used as a starting position to locate the position of the second byte of data from encoded message 302. Accordingly, the non-random pad may be again searched and the offset value may be computed for the second byte of data to be encoded. This pattern may be repeated until all of the data to be encoded has been processed into offsets.

By way of example and not limitation, the encoded message 314 may then be stored or transmitted by itself and may only be decoded by applying the offset series using the same non-random pad, e.g., non-random pad 304. In an embodiment, the size of data to be matched may be smaller or larger than a byte. Similarly, the size of each offset value may also be smaller or larger than a byte. In an embodiment, a starting offset may be applied before encoding starts, where doing so may alter a series of offsets resulting therefrom. The general shape and size of the non-random pad 304 is provided as a non-limiting example. Those skilled in the art will appreciate that other sizes, configurations and/or orientations of the non-random pad 304 may exist other than that shown in FIG. 3. Further, the non-random pad 304 is shown in FIG. 3 as having two dimensions only, e.g., a height and a width. In other embodiments, the non-random pad 304 may have higher dimensions, including depth, to be shaped generally as a cube and/or lattice. Still further, the non-random pad may have dimensions not capable of visual representation in traditional three-dimensional space, including, but not limited to, fourth, fifth and additional dimensions. Variations in dimensional orientation and/or configuration of the non-random pad may or may not influence the results for the offset encoding shown, depending on how the various offset distances 310 may be organized and/or calculated. As shown in FIG. 3, processing of the non-random pad 304 may be from left to right and top to bottom. In one or more other embodiments, a different algorithmic module could reverse processing operations of the non-random pad 304 to read from right to left and/or top to bottom and/or from a center to the peripheral edges and/or any combination thereof. Algorithmic module processing the non-random pad 304 may, in one or more embodiments, change directions during mid-processing.

In certain configurations or orientations of the non-random pad 304, a match for a data value may not be located therein. Such an occurrence can be addressed by having a maximum search length and applying a nonce value to a subsequent byte of data. A configuration option of the non-random pad-based encryption process 300 may be to have, as pre-determined, a range of values that imply that a particular value was not successfully located. For example (and not limitation thereto), a value may be chosen in a range and when an offset is applied a second value may be computed that, when applied to the value at the offset, produces a matching value. Using a range of values may allow for less repetition and may serve to discourage statistical analysis.

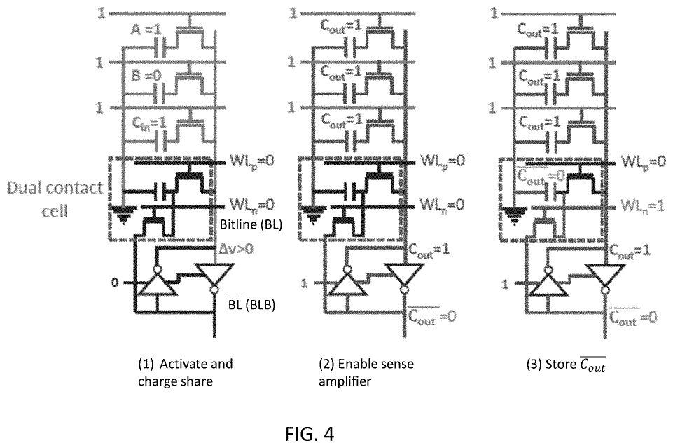

FIG. 4 illustrates an exemplary an offset representational algorithm module during decryption in accordance with an embodiment of the present invention. In the present embodiment, a non-random pad-based decryption process 400 may at least substantially repeat, but in reverse order and/or configuration, operations discussed related to the non-random pad-based encryption process 300. Such offset-based decoding may involve receiving an encoded message 402 having a set of offset values, e.g., “7, 3, 21, 7, 14, 12, 13” as shown and a non-random pad 404, which may be identical to the non-random pad 304 shown in FIG. 4, such that decoding module 406 may use the offset values 410 to traverse 408 the non-random pad 404 to extract the original data to produce fully-decoded and/or decrypted message 412. Those skilled in the art may appreciate that other variations and/or configurations may exist regarding decrypting an earlier encoded and/or encrypted message by the non-random pad-based decryption process 400. However, any and/or all variants of decryption processes must use the same non-random pad to conduct the earlier corresponding encryption; that is, non-random pad 304, 404 shown in FIGS. 3, 4, respectively, must be identical for successful encryption and decryption operations.

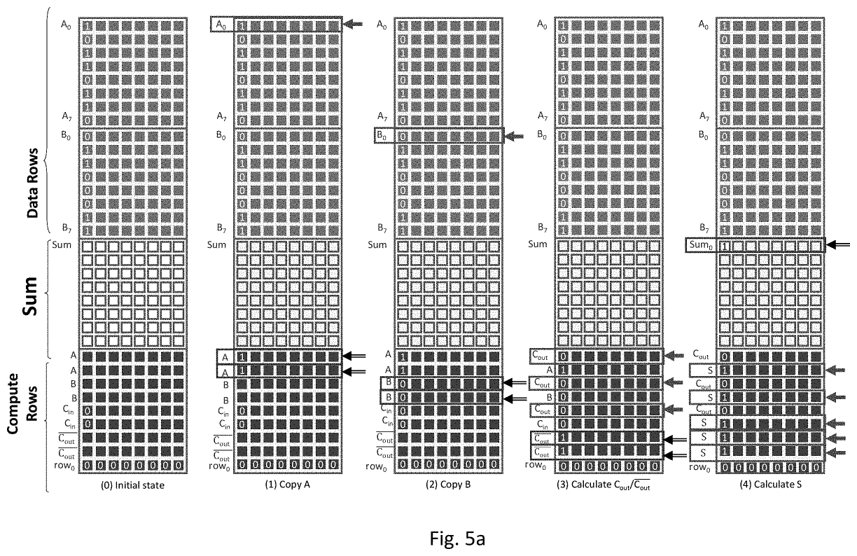

FIG. 5 illustrates an exemplary vector representational algorithm module during encryption. In the present embodiment, vector-encoding non-random pad-based encryption system 500 employs vector encoding 508, referring to techniques generally similar to that presented earlier regarding the traversal of a non-random pad; however, with vector encoding 508, processing algorithms traverse the non-random pad without being restrained to incremental movement in a specified single direction, e.g., left-to-right, but may instead skip in multiple dimensions to produce vector-based encoded message 514. That is, in an example operational procedure, vector-encoding non-random pad-based encryption system 500 may receive original message 502 to traverse a non-random pad 504 to locate values within a closest distance from an original start value, e.g., “K”, located at a designated start point on the non-random pad 504, e.g., the upper-left corner. Accordingly, vector encoding 508 of the non-random pad 504 may produce a list of vectors 512 that may be aggregated to form vector-based encoded message 514.

More particularly, by way of example and not limitation, vector encoding 508 may be a representational algorithm which takes original message 502 and non-random pad 504, which may be shaped pursuant to one or more shaping algorithms, and to produce a series or list of vectors 512 from the non-random pad that can be used to either encode or recreate original data. In an embodiment, vector encoding 508, which may be implemented in computer machinery as a module, communicates 506 with non-random pad 504 to search 510 therein from a start point, e.g., the letter “K” located in the upper-left, of the shaped non-random pad for a byte that matches the first byte of the data to be encoded. X-direction and y-direction positional values may be systematically computed from the starting byte to create the first vector value. The position of the first matching byte may then be used as the starting position of the second byte of data, e.g., to incrementally traverse the non-random pad 504, such that it is again searched and the x and y positional values are computed for the second byte of data to be encoded. This pattern may be repeated until all of the data to be encoded has been processed into vectors. Corresponding decryption may be accomplished by reversing the operation.

In one or more embodiments, there may be a mathematical relationship between offset and vector encoding that allows for conversion between two sets of representational data. Conversion of the vector representation to an offset representation may involve multiplying the Y value by the width and adding the X value. As shown in FIG. 3, offset values as calculated do not count matching values such that the computed values need to subtract 1 to match equivalent offset values. An inverse operation may be used to compute the vector values from an offset value. Similarly, a vector representation may be converted to directed and un-directed graphs as well as numerous types of data trees and other related data structures.

By way of example and not limitation, any one or more of the systems, methods of use and/or operation thereof, and/or modules may be implemented in a number of ways including (but not limited thereto): a network driver, a local service, a network device, as a set of micro-services distributed in a virtual or cloud environment, a client-service architecture on a traditional network or embedded in an application such as chat or email. Disclosed systems may be realized and/or implemented as pure software, pure hardware or a combination of the two.

If multiple copies of disclosed system are running on multiple machines then the pad creation modules, representational algorithm modules and media files used may need to be synchronized for successful data transformation operations. The distribution or exchanging of modules and media files necessary for such a synchronization may be accomplished in a variety of ways. Physical media including thumb drives, portable hard-drives, tape drives and solid-state devices, among others, may be used. Pad creation modules and/or media files may be provisioned over a secure network connection and/or through a third party trust server. Media files may be sourced from the web and may be negotiated prior to availability of the media, such as a weekly television show, daily news cast or sports event. Generated pads and other factors may be stored locally in a secure manner using one or more encrypted key stores.

The selection of media files and identifiers for pad creation and representative algorithms during messaging may also be accomplished in a variety of ways, methods and/or techniques. Factors can be configured in advance, generated systematically, negotiated on a per-session basis using a key exchange protocol such as Diffie-Helman or through a trust server. A common issue that may face large entities such as corporations is the “travelling salesman problem”, (e.g., as commonly understood in the art and as defined herein as referring to how to ensure security of assets which are used off-site and which may be exposed to unsafe environments and networks or which may be subject to inspection by third parties, such as at borders and customs), which may be solved using a cryptographic key generator that rotates keys on a schedule. Similar cryptographic technology may be implemented in any one or more of that shown in FIGS. 1-5 to cycle through media and indexes in a secure manner. Another approach may be to store multiple configurations of representational algorithms, media and pad creation algorithms, which may be implemented when off-site. After being implemented, the specific configuration including media and algorithmic modules, may be erased from the computer, resulting in that only the on-site system may have the correct configuration to be used for decryption. Accordingly, if a computer is lost, stolen or otherwise taken, any decrypted contents would still be considered secure due to the lack of the necessary configuration, algorithms and media.

An alternative to converting data to a representative form may be to use the non-random pad in a manner similar to random one-time pads (OTPs_. Random OTPs may be used to alter input data directly by an operation such as XOR. To retrieve the data, the XOR operation may reversed using a copy of the random OTP. Non-random pads can provide similar levels of security simply by combining multiple media files during creation. An attacker or adversary would need to know the media files used and the methods used to create the non-random pad to successfully reverse the XOR operation.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, without limitation, with a server or other machine sending signals to the local machine, which allows the local machine to carry out the operations described herein.

FIG. 6 illustrates an exemplary flow diagram of a method for applying a set of rules having media files and representative algorithms to encrypt and to decrypt data in discrete parts providing message secrecy, integrity and authenticity for communications and storage in accordance with an embodiment of the present invention. In the present embodiment, a method 600 may apply a set of rules having multiple media files and representative algorithms to encrypt and to decrypt data in discrete parts providing message secrecy, integrity and authenticity for communications and storage.

By way of example and not limitation, the method 600 may operate substantially as follows: a start operation 602 initiates method 600 followed by an acquisition operation 604 where data “D” may be acquired from one or more files and/or network streams, where “T” may be denoted for the total size of the data. Such acquired data at the acquisition operation may be passed to a rule algorithm application region 606 including: a determination operation 608, a configuration operation 610, a rule addition operation 612, a subsequent rule addition operation 614, a final rule set determination operation 616, a rule set acquisition operation 618 and a recycle passage 620.

In operation, for example (but without limitation thereto), data acquired from the acquisition operation may be passed to determination operation 608 for the determination of an appropriate rule and/or rules for application to the data, if needed (e.g., a rule set has not been yet determined, thus yielding a determination of “no” at determination operation 608). The data may be passed to configuration operation 610 that may determine whether a rule server responsible for storing and/or applying the rule and/or rules to the data is configured. If no, then the data passes to rule addition operation 612, and, optionally, to the subsequent addition of rules to, for example, without limitation, parse, process, flip, return, manipulate, or otherwise modify the data. If yes, then a rule set is acquired from a rule server at rule set acquisition operation 618 to be applied to the data. From either or both of the rule set acquisition operation 618 and/or the subsequent rule addition operation 614, data with a rule and/or rules applied thereto may pass and/or return to determination operation 608 by recycle passage 620 after being finally characterized by final rule set determination operation 616.

Should a rule set already be determined by the determination operation 608, data may pass via a passage 622, where “M” may represent the encrypted data and/or message, initially being empty; “P” may represent the size of the processed data, initially 0; “T” may represent the total size of the data; and, “R” may be the index of the current rule, initially the first rule identified and/or applied by, for example, without limitation, the rule algorithm application region 606.

Data passes through the passage 622 to a deciding point 624 where P is compared against T. Should P be not less than T, e.g., equal or greater to T, then the data may be saved and/or sent as message M at a save or send operation 634 to end method 600 at an end operation 636.

Alternatively, should P be less than T as calculated or otherwise determined at the deciding point 624, data may be passed to a rule application decision point. Should a determination of “yes” be provided to the application of rule R to the data, then the data may be passed to an intention of rule application operation 626. An indication of “yes” at the intention of rule application operation 626 may permit data to pass to a data size acquisition operation 628, where a size S block of data “B” from the data D may be acquired as determined by rule R, such that ‘data D=block B of rule 1+block B of rule 2+ . . . +block B of rule final’. In an embodiment, an indication of “no” at intention of rule application operation 626 skips the current rule during the current round of operation and passes control to a rule modification determination operation 640. Those skilled in the arts will recognize that a rule R may have been applied in previous rounds and may be applied again in subsequent rounds.

A size S block of data “B” acquired from the data D from data size acquisition operation 628 may be passed to a non-random pad acquisition operation 630 where a pad “N” is acquired as determined by rule R. The block B and pad N may be passed to cypher production operation 632, where the pad “N” may be applied to a block “B” of the data to produce cypher block “C’, which may then be appended at an append operation 638 to the message M, e.g., such that ‘encrypted message M=cypher C of rule 1+cypher C of rule 2+ . . . +cypher C of rule final’. Each rule in the rule set may contain a unique combination of algorithms, data sizes, initial offsets, counters and media files that are used to encrypt and decrypt data as needed.

Should a determination of “no” be provided to the application of rule R to the data at the intention of rule application operation 626 or if an append operation 638 has completed, operation will be passed to a rule modification determination operation 640.

In operation, data may be passed to modification determination operation 640 that assesses whether rule R modifies other rules, if “yes” then operation will be passed to rule acquisition operation 642 where additional rules are acquired to be modified by rule R. Data may then be passed to rule application operation 644 to apply rule R to a list of modified rules prior to the data being passed to an incremental assessment point 646, where R+1 is compared against N. Should R+1 be less than N, yielding a determination of “yes”, then the data may be passed, via a pathway 648, to a rule augmentation operation 650 where rules may be augmented according to the following formula: R_{final}=R_{incremental}+1 to return the data to deciding point 624 to repeat the assessment there until all data is assessed to be ready for saving or sending at the save or send operation 634. Should R+1 not be less than N, e.g., R+1, is equal to or greater than N, then R may be set to the first rule at a rule set operation 652 prior to the data returning to deciding point 624 for assessment therein. Those skilled in the art will readily recognize, in view of the teachings of the disclosed embodiments that the configuration of the various operations discussed for method 600 is provided as an example only and that other suitable variations of the operations may exist without departing from the scope and spirit of the disclosed embodiments.

FIG. 7 illustrates an exemplary flow diagram of a method for applying a set of rules having multiple media files and cryptographic algorithms to generate non-random pads for later communications and storage operations in accordance with an embodiment of the present invention. In the present embodiment, a method 700 may apply a set of rules having multiple media files and representative algorithms to generate a non-random pad for later secure communications and storage.

By way of example and not limitation, the method 700 may operate substantially as follows: a start operation 702 initiates method 700 followed by a rule algorithm application region 704 including: a determination operation 706, a configuration operation 708, a rule addition operation 710, a subsequent rule addition operation 712, a final rule set determination operation 714, a rule set acquisition operation 716 and a recycle passage 718.

In operation, for example (but without limitation thereto), the determination operation 706 is only called if needed (e.g., a rule set has not been yet determined, thus yielding a determination of “no” at determination operation 706). Operation may be passed to configuration operation 708 that may determine whether a rule server responsible for storing and/or applying the rule and/or rules to the data is configured. If no, then the operation passes to rule addition operation 710, and, optionally, to the subsequent addition of rules to, for example, without limitation, parse, process, flip, return, manipulate, or otherwise modify the data. If yes, then a rule set is acquired from a rule server at rule set acquisition operation 716 to be applied to the data. From either or both of the rule set acquisition operation 716 and/or the subsequent rule addition operation 714, a rule and/or rules applied thereto may pass and/or return to determination operation 706 by recycle passage 718 after being finally characterized by final rule set determination operation 714. [Basically, and this applies to the similar passage from FIG. 6, rules combine all operations into a modularized form that may include media files and/or representative algorithms (for FIG. 6) and media files and/or basic transforms (for FIG. 7).]

Should a rule set already be determined by the determination operation 706, operation may pass via a passage 720, where “P” may represent the non-random pad, initially being empty; “T” may be the total size of the desired non-random pad and, “R” may be the index of the current rule, initially the first rule identified and/or applied by, for example, without limitation, the rule algorithm application region 706.

Operation passes through the passage 720 to a deciding point 722 where “P” is compared against “T”. Should “P” be not less than “T”, e.g., equal or greater to “T”, then the data may be saved and/or sent as message “P” at a save or send operation 732 to end method 700 at an end operation 734. Alternatively, should “P” be less than “T” as calculated or otherwise determined at the deciding point 722, data may be passed to a rule application decision point 724. [Basically, continue appending blocks to the pad until it is the desired size.]

An indication of “yes” at the intention of rule application operation 724 may permit operation to pass to a binary block creation region 726 including: a media acquisition operation 728, a cypher production operation 730, an intention of cypher application operation 726 and an append operation 738. Rule R may be passed to a media acquisition operation 728, where a media file “M” or previously saved block “B” may be acquired as determined by “R”. In an embodiment, an indication of “no” at intention of cypher application operation 736 may permit data to pass and return from to an append operation 738 further described below.

A media file “M” or block “B” acquired during the media acquisition operation 728 may be passed to a cypher production operation 730, where the rule “R” may be applied to a media file “M” or block “B” of the data to produce cypher block “Q”, which is then passed to a decision block 736, where a save or append operation is indicated by rule “R”. An indication of “no” at decision block 734 may result in storing “Q” in the set of blocks “B”. An indication of “yes” at decision block 734 may result in a cypher block “Q” may then be appended at an append operation 732 to the non-random pad P, e.g., such that P_{final}=P_{incremental}+Q.

Should a determination of “no” be provided to the application of rule R to the data at the intention of rule application operation 724, data may be passed to a modification determination operation 740. In operation, data may be passed to modification determination operation 740 that assesses whether rule R modifies other rules, if “yes” then data may be passed to rule acquisition operation 742 where additional rules are acquired to be modified by rule R. Data may then be passed to rule application operation 744 to apply rule R to a list of modified rules prior to the data being passed to an incremental assessment point 746.

The current rule R is passed to an incremental assessment point 746, where R+1 is compared against N, the total number of rules in the rule set. Should R+1 be less than N, yielding a determination of “yes”, then the data may be passed, via a pathway 748, to a rule augmentation operation 750 where rules may be augmented according to the following formula: R_{final}=R_{incremental}+1 to return the data to deciding point 724 to repeat the assessment there until all data is assessed to be ready for saving or sending at the save or send operation 734. Should R+1 not be less than N, e.g., R+1, is equal to or greater than N, then R may be set to the first rule at a rule set operation 752 prior to the data returning to deciding point 724 for assessment therein. Those skilled in the art will readily recognize, in view of the teachings of the disclosed embodiments that the configuration of the various operations discussed for method 700 is provided as an example only and that other suitable variations of the operations may exist without departing from the scope and spirit of the disclosed embodiments.

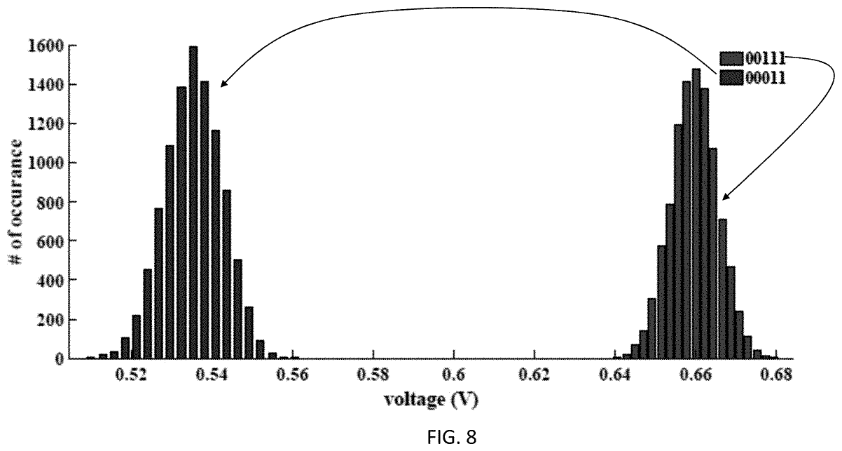

FIG. 8 illustrates an exemplary block diagram denoting the components of a representative cryptographic and non-random pad creation service and a rule server associated therewith, both the representative cryptographic and non-random pad creation service and the rule server having multiple modules and libraries consisting of media files and algorithms to generate non-random pads [Non-random pads do not meet the standards of a typical OTP] and to encrypt and to decrypt data in discrete parts providing message secrecy, integrity and authenticity for communications and storage in accordance with an embodiment of the present invention. In the present embodiment, a cryptographic system 800 includes a representative cryptographic and non-random pad creation service 802 in electronic communication with a rule server 804. Both the cryptographic service 802 and rule server 804 may be installed on and/or with a computer-based system and/or network requiring at least intermittent usage of one or more pieces of computer hardware, e.g., processor(s) and/or non-transitory memory, for required functionality and/or operation.

Generally, the representative cryptographic and non-random pad creation service 802 refers to software that applies a set of rules, consisting of multiple media files and algorithms, to generate one-time pads and to encrypt and decrypt data in discrete parts providing message secrecy, integrity and authenticity for communications and storage. In an embodiment, the representative cryptographic and non-random pad creation service 802 may include a set of rules with each rule containing a unique combination of algorithms, data sizes, initial offsets, counters and media files that are used to encrypt and decrypt data and to create one-time pads. By way of example and not limitation, rules may be arbitrarily complex and may reference other rules; use any existing cryptographic methods; and make modifications to the rule set (including self-modification). In one or more embodiments, a rule set may be acquired from a rule server or otherwise be manually generated; and, a set of rules may be arbitrarily large where, during typical operation, only a subset of the set of rules may be selected and/or implemented for a particular operation.

In an embodiment, the representative cryptographic and non-random pad creation service 802 and/or rule server 804 can individually and/or in unison encrypt and/or decrypt any digital data, including local files and network streams, using a set of rules. The rules used during encryption must be reversible for decryption to be possible. When data is received by the representative cryptographic service, e.g., via a data input 810 with File, Net and Web interfaces 808, a subset of rules may be acquired, e.g., from a rule manager 820 in communication with the rule server 804 storing, at least, rules 848, where a first or initial rule from rules 848 may be applied or implemented. Each rule may define a block size used where the block may be acquired from data, e.g., as provided by the data input 810. Should an initial offset operation be implemented as a part of implementation of the first rule, the first rule may skip forward by a data sequence or position commensurate with the offset operation in the acquired data when acquiring the first block. In an embodiment, each rule in the rule set may be applied to the data until all data is consumed, including any data initially skipped by the offset operation. Moreover, in one or more embodiments, rules may modify other rules including themselves based on counters, the amount of data processed, or other criteria and/or triggering conditions.

In one or more embodiments, the non-random pad creation service 802 and/or the rule server 804 can individually or in unison create non-random pads using media files and a set of rules. Media files could include audio, video, executable, one-time pads, previously generated non-random pads and other binary data files. Rules, as being used or otherwise implemented during non-random pad creation, do not have to be reversible as is necessary when used during encryption and decryption. In an embodiment, to create a non-random pad, rules are applied to media files to transform digital data, e.g. as acquired from the data input 810, into cryptographically unique data. Generated non-random pads can be used during encryption and decryption by applying an XOR function with the data, in a manner similar to OTPs, or in one or more embodiments, implementations and/or integrations of any combination of offset, vector and graph-based cryptography.

Returning to the cryptographic system 800 shown in FIG. 8, the cryptographic system 800 may be implemented and/or integrated with any one or more of the modules and/or systems shown and discussed in connection with FIGS. 1-6 to, for example, perform and/or otherwise at least assist with the encryption and/or decryption of raw data resulting in the transformation of raw data into encrypted data and/or vice-versa for any one or more end-used applications or configurations that may be desired by a human and/or computer-based end user. In an embodiment, the representative cryptographic and non-random pad creation service 802 may include a GUI, REST and/or CLI modules embedded therewith for electronic communication with any one or more selected from a group including: the data input 810 (e.g., inclusive of files, local intra-net, or global Internet, e.g., web, based sources); an encryption module 812, a decryption module 814, and/or a non-random pad generator 816. Those skilled in the art will appreciate that the modules and/or generators provided herein are by example and not limiting. Other suitable modules and/or generators may exist suitable for the purposes of data transformation from raw data to encrypted data and vice-versa. A rules processor 818, also embedded within and/or otherwise associated with the representative cryptographic and non-random pad creation service, may electronically communicate with any one or more of the data input 810, the encryption module 812, the decryption module 814, and/or the non-random pad generator 816 to further process data acquired from, e.g., the data input 810 as may be dictated by, for example (and not limitation thereto) the rule manager 818. In one or more embodiments, various media 822 and/or pads 824 may be associated with the rule manager 818 and/or otherwise be embedded or included in the representative cryptographic and non-random pad creation service 802 for access by the rule manager 818 to further process and/or transform data pursuant to one or more rules 848 as accessed from the rule server 804.

Rules can be configured for multiple reasons including, but not limited to: speed, efficiency, strength, use count, and reliability. In this case, offset cryptography is fast, efficient, strong, is reusable and should be reliable in all cases. Graph and vector based cryptographic systems can be converted from and to offset cryptography, however if all three systems are used in conjunction, then an attacker would have an additional factor needing to be compromised. Other forms of representative cryptography include, but are not limited to: using chapter, paragraph, sentence, word, and letter placement values from text files, using frame, line, column, and color values from video files, and using album, song, and time offset from an audio recording.

By way of example and not limitation, such implementation of rules from the rule server 804 as conducted and/or otherwise performed by the representative cryptographic and non-random pad creation service 802 includes implementation of one or more data primitive operations 826 inclusive of (by way of example and not limitation): shaping, shuffling, rotation, flipping, joining, splitting, and/or reversal. Moreover, in combination with or in lieu of, data, subject to rules promulgated by the rule manager 818 may be subject to further and/or alternative transformation by various specific cryptographic plugins, inclusive of (by way of example and not limitation): a graph plug-in 830, an offset plug-in 832, and an OTP plug-in 834, among others.

Each cryptographic plug-in can have multiple parameters that a rule can use to create unique operations. Further, rules can edit their own parameters as well as the parameters of other rules. Rules can also destruct themselves as well as other rules and can destroy non-random pads and representative algorithmic modules that have been used during operations. Destruction or removal of these items from the host system provides additional security in the event of an attacker gaining remote or physical access to the host. Those skilled in the art may appreciate that the plug-ins, identified by their typical industry acronyms, may function substantially as per industry paradigm and/or include any suitable variant thereof.

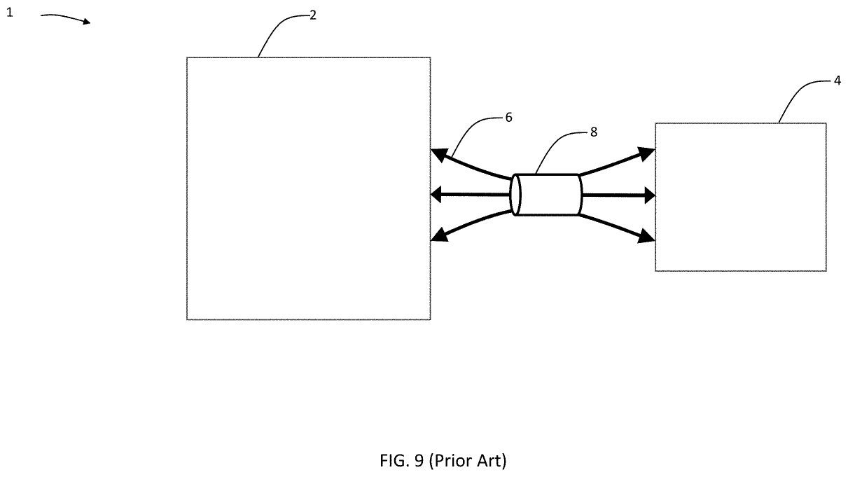

FIG. 9 illustrates exemplary data primitive operations for rules, the rules including various algorithms, keys, pads and media, the data primitive operations including sizing, shaping, shuffling, rotating, flipping, splitting, joining and reversing the data in accordance with an embodiment of the present invention. In the present embodiment, data, as generally understood and as referred to herein, includes a set of values of subjects with respect to qualitative or quantitative variables. Data and information or knowledge are may be used and/or referred to interchangeably; however, data may become information when it is viewed in context or in post-analysis. Data primitive operations 900, generally, may refer to basic computations performed by an algorithm. Examples are evaluating an expression, assigning a value to a variable, indexing into an array, calling a method, returning from a method, etc. They are easily identifiable in pseudocode and largely independent from the programming language. [Source: https://www.cpp.edu/˜ftang/courses/CS240/lectures/analysis.htm; 06-22-19]. Data primitive operations 900 may be used during non-random pad creation. FIG. 9 shows a tiny subset of the vast number of operations available, which is why data primitive operations 900 are a good factor in pad creation and for use in cryptography.

Data primitive operations 900, in an embodiment, may manipulate data primitives and/or primitive data types, which may refer to, generally, either of the following: (1) a “basic type” is a data type provided by a programming language as a basic building block; many computing languages may allow more complicated composite types to be recursively constructed starting from basic types; (2) “a built-in” type is a data type for which the programming language provides built-in support.

In one or more embodiments, the data primitive operations 900 may manipulate such data primitives, primitive data types, and/or data, such as data 902, as so described, by, for example (but without limitation thereto) the following operations: a vertical halving, quartering and shuffle operation 904, a horizontal quartering, shuffle and rotate operation 906, a rotate, halve, apply specific pads to specific parts, and shuffle operation 908, and rotate, quarter, and shuffle operation 910.

Each data primitive operation 904-910 may function substantially as shown in FIG. 9 to manipulate the data 902. That is, vertical halving operation 904 may receive data 902 input there-into to vertically halve the data, quarter both vertical halves, and shuffle the data 902 horizontally. The horizontal halving operation 906 may receive data 902 input there-into to halve the data 902 horizontally and, for example (but without limitation thereto), apply a first key (e.g., “Key 1”) to a first part of the halved data (e.g., “Part 1”), and to apply a second key (e.g., “Key 2”) to a second part of the halved data (e.g., “Part 2”). The quarter, shuffle, and rotate operation 908 may receive data 902 input there-into to horizontally quarter the data 902 prior to shuffling the data 902 and rotating the data 902 180°. The rotate, halve, apply specific pads to specific parts, and shuffle operation 910 may receive data 902 input there-into to perform at least the following operations (in the order listed and/or in any other order): (1) rotate the data 902 by 90°; (2) halve the data 902 vertically; (3) apply a first pad, e.g., such as a one-time pad and/or a non-random pad, also referred to as “Pad 1” to a first part defined by the vertical halving, e.g., referred to as “Part 1” and apply a second pad, e.g., such as a one-time pad and/or a non-random pad, also referred to as “Pad 2” to a second part defined by the vertical halving, e.g., referred to as “Part 2”; and, (4) shuffle the data 902. The rotate, quarter, and shuffle operation 912 may receive data 902 input there-into to perform at least the following operations (in the order listed and/or in any other order): (1) rotate the data 902 by 90°; (2) quarter the data 902 vertically; and, (3) shuffle the data 902 vertically. Those skilled in the art will appreciate that the data primitive operations 904-912 are provided as an example only and that an innumerable number of other data primitive operations 900 may exist able to manipulate and/or transform the data 902 in an innumerable number of ways and/or methods, etc.

In one or more embodiments, the data 902 may be shaped as “Media 1” defined as a 6×6 block 912 of data and/or may be shaped as “Media 2” also defined as a 6×6 block 914 of data. The data 902 may be subject to: vertical data combination operations that include any one or more of operations 916-920; horizontal data combination operations 922-926; shuffle operations 928-932, and quarter then shuffle operations 934 and 936. Those skilled in the art that such operations 916-936 are provided as an example only and are thus non-limiting and that an innumerable number of other data primitive operations 900 may exist able to manipulate and/or transform the data 902 in an innumerable number of ways and/or methods, etc.

As shown in FIG. 9, in one or more embodiments, the data 902 may be transformed into a two dimensional shape, such as a 3×3 square 938, and rotated around an intersection, such as the middle cells 940 or the intersection of the lower left cells 942. It is well known in the art that a grid, including grids that are not of equal length and width, can be rotated around any cell intersection and produce dissimilar results. Similar to other data primitive operations 900, cell rotation is a good factor for cryptography.

FIG. 10 illustrates exemplary data primitive operations for rules including partitioning and assembly during pad creation, the rules including various algorithms, keys, pads and media, the data primitive operations including sizing, shaping, shuffling, rotating, flipping, splitting, joining and reversing the data in accordance with an embodiment of the present invention. Data transformation process 1002, in an embodiment, may involve the application or otherwise functional integration of a digital pad, e.g., an OTP or a non-random pad, to provide an encryption key for the transformation (e.g., encryption) of incoming raw data 1004. Application of a non-random pad 1006 to the raw data 1004 using a representational cryptographic algorithm may result in unbreakable encryption. This is as opposed to OTP operations when, as conducted at commonly known in the art, e.g., requiring, for example (but without limitation thereto) that the OTP: (1) is at least as long as the message or data that must be encrypted; (2) is truly random (not generated by a simple computer function or such); (3) OTP and/or plaintext associated therewith are calculated modulo 10 (digits), modulo 26 (letters) or modulo 2 (binary); (4) is used only once, where such usage may involve the application of incoming raw data to the OTP via modular addition (e.g., referring to a system of arithmetic for integers, where numbers “wrap around” upon reaching a certain value); (5) there should only be two copies of the key: one for the sender and one for the receiver (some exceptions exist for multiple receivers); and, (6) both sender and receiver must destroy their key after use. Alternatively, in one or more embodiments, application of a non-random pad 1006 to the raw data 1004 may permit for repeat usage of the non-random pad to encrypt incoming raw data supplied thereto by finding the bits or characters that compose the raw data in the non-random pad using a search algorithm 1008 and recording the number of intervening bits or characters between matches to produce a cypher of the original message 1010. The cypher text can be transmitted to a client or server via a network 1012.

A client or server may receive the cypher text via a network 1014. The cypher text 1016 can then be applied to a local copy of the non-random pad 1018. Substantially similar to the data transformation process 1008, data transformation process 1018, in an embodiment, may perform one or more operations to transform, e.g., decrypt, the offset-based encrypted data 1010 transmitted via or stored in the cloud 1012 using the same non-random pad 1008. The first offset is used to find the first bits or characters in the original data. The rest of the original data is extracted from the non-random pad by applying the next offset value to the location pointer. The offset values have no relationship to the value of the bits or characters that are found in the non-random pad 1018. The bits or characters extracted from the non-random pad using the offsets identically match raw data 1020. Those skilled in the art will appreciate that the offset-based decryption operations 1018 at least substantially resemble and/or mimic the offset-based encryption operations 1008; however, other suitable variations in configuration and/or data flow may exist without departing from the scope and spirit of data transformation back to producing fully decrypted message as raw data 1020, e.g., any one or more of encryption 1008 or decryption 1018 operations may be implemented and/or practiced in an order or configuration other than that shown for data transformation process 1002 but still produce the raw data 1020.

A non-random pad can be created as shown by (but not limited to) that set forth in a rule set 1024 that includes at least the following operations (where identifiers “M1” . . . etc. may refer to specific packets and/or groupings of data and/or media files 1026): (1) shuffle M1 and M3, save as M5; (2) shuffle M2 and M4, save as M6; (3) conduct and XOR operation on M1 and M3, save as M5; (4) conduct an XOR operation on M2 and M3, save as M6; (5) shuffle M5 and M6, save as a pad; (6) conduct an XOR operation on M5 and M6, save as a pad; (7) split pad vertically, swap; (8) split pad horizontally, swap; (9) split pad vertically, swap; (10) split pad horizontally, swap. Those skilled in the art will appreciate that operations (1)-(10) of the rule set 1024 are provided as an example only and that an innumerable number of other operations may exist able to manipulate and/or transform the media files in an innumerable number of ways and/or methods, etc.

In one or more embodiments, the media files 1026 may include the following: (1) M1, which is a streaming video capable to be streamed on an online website such, but not limited to, YouTube®; M2, which is a streaming video capable to be streamed on an online website such, but not limited to, YouTube®; M3, which is a streaming video capable to be streamed via a cellular service; and, M4, which is a streaming video capable to be streamed via a cellular service. Such media files 1026 may be subject to the rule set 1024 that may include an arbitrary number of rules to create a pad, such the subset of rules 1030, which may be suitable for functional inclusion with any one or more of the methods, operations, passages, and/or transformations shown in FIGS. 1-8 and described in connection therewith regarding the transformation of media files to a non-random pad 1032.

Integration of the Disclosed Embodiments with an Example Client/Server Systems

FIG. 11 illustrates an exemplary block diagram depicting an example client/server system that may be used by an example web-enabled/networked embodiment of the present invention.

A communication system 1100 includes a multiplicity of clients with a sampling of clients denoted as a client 1102 and a client 1104, a multiplicity of local networks with a sampling of networks denoted as a local network 1106 and a local network 1108, a global network 1110 and a multiplicity of servers with a sampling of servers denoted as a server 1112 and a server 1114.

Client 1102 may communicate bi-directionally with local network 1106 via a communication channel 1116. Client 1104 may communicate bi-directionally with local network 1108 via a communication channel 1118. Local network 1106 may communicate bi-directionally with global network 1110 via a communication channel 1120. Local network 1108 may communicate bi-directionally with global network 1110 via a communication channel 1122. Global network 1110 may communicate bi-directionally with server 1112 and server 1114 via a communication channel 1124. Server 1112 and server 1114 may communicate bi-directionally with each other via communication channel 1124. Furthermore, clients 1102, 1104, local networks 1106, 1108, global network 1110 and servers 1112, 1114 may each communicate bi-directionally with each other.

In one embodiment, global network 1110 may operate as the Internet. It will be understood by those skilled in the art that communication system 1100 may take many different forms. Non-limiting examples of forms for communication system 1100 include local area networks (LANs), wide area networks (WANs), wired telephone networks, wireless networks, or any other network supporting data communication between respective entities.

Clients 1102 and 1104 may take many different forms. Non-limiting examples of clients 1102 and 1104 include personal computers, personal digital assistants (PDAs), cellular phones and smartphones.

Client 1102 includes a CPU 1126, a pointing device 1128, a keyboard 1130, a microphone 1132, a printer 1134, a memory 1136, a mass memory storage 1138, a GUI 1140, a video camera 1142, an input/output interface 1144 and a network interface 1146.

CPU 1126, pointing device 1128, keyboard 1130, microphone 1132, printer 1134, memory 1136, mass memory storage 1138, GUI 1140, video camera 1142, input/output interface 1144 and network interface 1146 may communicate in a unidirectional manner or a bi-directional manner with each other via a communication channel 1148. Communication channel 1148 may be configured as a single communication channel or a multiplicity of communication channels.

CPU 1126 may be comprised of a single processor or multiple processors. CPU 1126 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 1136 is used typically to transfer data and instructions to CPU 1126 in a bi-directional manner. Memory 1136, as discussed previously, may include any suitable computer-readable media, intended for data storage, such as those described above excluding any wired or wireless transmissions unless specifically noted. Mass memory storage 1138 may also be coupled bi-directionally to CPU 1126 and provides additional data storage capacity and may include any of the computer-readable media described above. Mass memory storage 1138 may be used to store programs, data and the like and is typically a secondary storage medium such as a hard disk. It will be appreciated that the information retained within mass memory storage 1138, may, in appropriate cases, be incorporated in standard fashion as part of memory 1136 as virtual memory.

CPU 1126 may be coupled to GUI 1140. GUI 1140 enables a user to view the operation of computer operating system and software. CPU 1126 may be coupled to pointing device 1128. Non-limiting examples of pointing device 1128 include computer mouse, trackball and touchpad. Pointing device 1128 enables a user with the capability to maneuver a computer cursor about the viewing area of GUI 1140 and select areas or features in the viewing area of GUI 1140. CPU 1126 may be coupled to keyboard 1130. Keyboard 1130 enables a user with the capability to input alphanumeric textual information to CPU 1126. CPU 1126 may be coupled to microphone 1132. Microphone 1132 enables audio produced by a user to be recorded, processed and communicated by CPU 1126. CPU 1126 may be connected to printer 1134. Printer 1134 enables a user with the capability to print information to a sheet of paper. CPU 1126 may be connected to video camera 1142. Video camera 1142 enables video produced or captured by user to be recorded, processed and communicated by CPU 1126.

CPU 1126 may also be coupled to input/output interface 1144 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1126 optionally may be coupled to network interface 1146 which enables communication with an external device such as a database or a computer or telecommunications or internet network using an external connection shown generally as communication channel 1116, which may be implemented as a hardwired or wireless communications link using suitable conventional technologies. With such a connection, CPU 1126 might receive information from the network, or might output information to a network in the course of performing the method steps described in the teachings of the present invention.

FIG. 12 illustrates an exemplary block diagram depicting an example client/server communication system that may be used for a cryptographic security system using representative cryptographic encryption and/or decryption and/or pad creation in accordance with an embodiment of the present invention. A communication system 1200 includes a multiplicity of networked regions with a sampling of regions denoted as a network region 1202 and a network region 1204, a global network 1206 and a multiplicity of servers with a sampling of servers denoted as a server device 1208 and a server device 1210.

Network region 1202 and network region 1204 may operate to represent a network contained within a geographical area or region. Non-limiting examples of representations for the geographical areas for the networked regions may include postal zip codes, telephone area codes, states, counties, cities and countries. Elements within network region 1202 and 1204 may operate to communicate with external elements within other networked regions or within elements contained within the same network region.

In some implementations, global network 1206 may operate as the Internet. It will be understood by those skilled in the art that communication system 1200 may take many different forms. Non-limiting examples of forms for communication system 1200 include local area networks (LANs), wide area networks (WANs), wired telephone networks, cellular telephone networks or any other network supporting data communication between respective entities via hardwired or wireless communication networks. Global network 1206 may operate to transfer information between the various networked elements.

Server device 1208 and server device 1210 may operate to execute software instructions, store information, support database operations and communicate with other networked elements. Non-limiting examples of software and scripting languages which may be executed on server device 1208 and server device 1210 include C, C++, C# and Java.

Network region 1202 may operate to communicate bi-directionally with global network 1206 via a communication channel 1212. Network region 1204 may operate to communicate bi-directionally with global network 1206 via a communication channel 1214. Server device 1208 may operate to communicate bi-directionally with global network 1206 via a communication channel 1216. Server device 1210 may operate to communicate bi-directionally with global network 1206 via a communication channel 1218. Network region 1202 and 1204, global network 1206 and server devices 1208 and 1210 may operate to communicate with each other and with every other networked device located within communication system 1200.

Server device 1208 includes a networking device 1220 and a server 1222. Networking device 1220 may operate to communicate bi-directionally with global network 1206 via communication channel 1216 and with server 1222 via a communication channel 1224. Server 1222 may operate to execute software instructions and store information.

Network region 1202 includes a multiplicity of clients with a sampling denoted as a client 1226 and a client 1228. Client 1226 includes a networking device 1234, a processor 1236, a GUI 1238 and an interface device 1240. Non-limiting examples of devices for GUI 1238 include monitors, televisions, cellular telephones, smartphones and PDAs (Personal Digital Assistants). Non-limiting examples of interface device 1240 include pointing device, mouse, trackball, scanner and printer. Networking device 1234 may communicate bi-directionally with global network 1206 via communication channel 1212 and with processor 1236 via a communication channel 1242. GUI 1238 may receive information from processor 1236 via a communication channel 1244 for presentation to a user for viewing. Interface device 1240 may operate to send control information to processor 1236 and to receive information from processor 1236 via a communication channel 1246. Network region 1204 includes a multiplicity of clients with a sampling denoted as a client 1230 and a client 1232. Client 1230 includes a networking device 1248, a processor 1250, a GUI 1252 and an interface device 1254. Non-limiting examples of devices for GUI 1238 include monitors, televisions, cellular telephones, smartphones and PDAs (Personal Digital Assistants). Non-limiting examples of interface device 1240 include pointing devices, mousse, trackballs, scanners and printers. Networking device 1248 may communicate bi-directionally with global network 1206 via communication channel 1214 and with processor 1250 via a communication channel 1256. GUI 1252 may receive information from processor 1250 via a communication channel 1258 for presentation to a user for viewing. Interface device 1254 may operate to send control information to processor 1250 and to receive information from processor 1250 via a communication channel 1260.

For example, without limitation, consider the case where a user interfacing with client 1226 may want to execute a networked application. A user may enter the IP (Internet Protocol) address for the networked application using interface device 1240. The IP address information may be communicated to processor 1236 via communication channel 1246. Processor 1236 may then communicate the IP address information to networking device 1234 via communication channel 1242. Networking device 1234 may then communicate the IP address information to global network 1206 via communication channel 1212. Global network 1206 may then communicate the IP address information to networking device 1220 of server device 1208 via communication channel 1216. Networking device 1220 may then communicate the IP address information to server 1222 via communication channel 1224. Server 1222 may receive the IP address information and after processing the IP address information may communicate return information to networking device 1220 via communication channel 1224. Networking device 1220 may communicate the return information to global network 1206 via communication channel 1216. Global network 1206 may communicate the return information to networking device 1234 via communication channel 1212. Networking device 1234 may communicate the return information to processor 1236 via communication channel 1242. Communication channel 1246 may communicate the return information to GUI 1238 via communication channel 1244. User may then view the return information on GUI 1238.

### Practice of Method Steps or Components Outside of the US

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, without limitation, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6)/(f) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6) pre-AIA or 35 USC § 112 (f) post MA. In some embodiments, the methods and/or system components which may be located and/or performed remotely include, without limitation: any one or more of the cryptographic system 100 shown in FIG. 1 and/or any one or more of the systems and/or modules shown and discussed in connection FIGS. 2-5

It is noted that according to USA law, all claims must be set forth as a coherent, cooperating set of limitations that work in functional combination to achieve a useful result as a whole. Accordingly, for any claim having functional limitations interpreted under 35 USC § 112 (6)/(f) where the embodiment in question is implemented as a client-server system with a remote server located outside of the USA, each such recited function is intended to mean the function of combining, in a logical manner, the information of that claim limitation with at least one other limitation of the claim. For example, without limitation, in client-server systems where certain information claimed under 35 USC § 112 (6)/(f) is/(are) dependent on one or more remote servers located outside the USA, it is intended that each such recited function under 35 USC § 112 (6)/(f) is to be interpreted as the function of the local system receiving the remotely generated information required by a locally implemented claim limitation, wherein the structures and or steps which enable, and breathe life into the expression of such functions claimed under 35 USC § 112 (6)/(f) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present patent application, and “35 USC § 112 (6)/(f)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a cryptographic data security system using non-random pads and representative algorithms, in a configurable encryption/decryption system, using certain embodiments of the invention, permit for data from a file or stream to be encoded using offsets into matching data in the non-random pad and describing the transform as a set of integers, undirected graphs or vectors according to the present invention will be apparent to those skilled in the art. Various aspects of the invention have been described above by way of illustration, and the specific embodiments disclosed are not intended to limit the invention to the particular forms disclosed. The particular implementation of a cryptographic data security system using non-random pads and representative algorithms, in a configurable encryption/decryption system, using certain embodiments of the invention, permit for data from a file or stream to be encoded using offsets into matching data in the non-random pad and describing the transform as a set of integers, undirected graphs or vectors may vary depending upon the particular context or application. By way of example, and not limitation, the cryptographic data security system using non-random pads and representative algorithms, in a configurable encryption/decryption system, using certain embodiments of the invention, permit for data from a file or stream to be encoded using offsets into matching data in the non-random pad and describing the transform as a set of integers, undirected graphs or vectors described in the foregoing were principally directed to data encryption and/or decryption implementations; however, similar techniques may instead be applied to other areas and/or fields of computer science and/or data management, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A cryptographic method, comprising the steps of:
receiving data;
retrieving an identifier for determining a non-random pad and a representative cryptographic algorithm;
retrieving the non-random pad associated with the identifier; and
applying the representative cryptographic algorithm to the received data using the retrieved non-random pad to generate output data.

2. The method of claim 1, in which the received data is raw data and in which the applying the representative cryptographic algorithm to the received data using the retrieved non-random pad further comprises the step of encrypting the received data by applying the representative algorithm to the non-random pad to produce a sequence of values that are distinct from the received data.

3. The method of claim 1, in which the received data is encrypted data and in which the applying the representative cryptographic algorithm to the received data using the retrieved non-random pad further comprises the step of decrypting the received data by applying the non-random pad to the encrypted data to produce raw data.

4. The method of claim 1, in which the retrieving the non-random pad further comprises acquiring media files and applying a set of rules determined by the identifier to create the non-random pad.

5. The method of claim 1 further comprising the steps of applying an offset to the non-random pad prior to applying the representative cryptographic algorithm to the received data using the retrieved non-random pad.

6. The method of claim 1 further comprising the steps of receiving configuration data for creating the non-random pad including receiving a list of pad creation rules, the identifier, an offset, and identification of sources of media files.

7. The method of claim 1 further comprises the step of receiving the data by a data handler, the data handler providing the received data to a pad handler, receiving representative algorithms, offsets, and pad identifiers by a security controller, providing, by the security controller, the representative algorithms, offsets, and pad identifiers to the pad handler, receiving, by the pad handler, non-random pads based on the pad identifiers, providing the non-random pads, the offsets, and the representative algorithms, from the pad handler to a conversion handler, producing output data by applying the offsets and the representative cryptographic algorithms to the received data using the non-random pad, and destroying the non-random pad used by the conversion handler.

8. A cryptographic system, comprising:
a data handler operable to receive data;
a security controller configured to retrieve an identifier used to determine a non-random pad and a representative cryptographic algorithm;
a pad handler configured to retrieve the non-random pad associated with the identifier; and
a conversion handler configured to apply the representative cryptographic algorithm to the received data using the retrieved non-random pad to generate output data.

9. The method of claim 8, in which the received data is raw data, and in which the conversion handler is further configured to encrypt the raw data by applying the representative algorithm to the non-random pad to produce a sequence of values that are distinct from the received data.

10. The method of claim 8, in which the received data is encrypted data and in which the conversion handler is further configured to decrypt the encrypted data by applying the non-random pad to the encrypted data to produce raw data.

11. The method of claim 8, in which the pad handler is configured to acquire media files and to apply a set of rules determined by the identifier to create the non-random pad.

12. The method of claim 8, in which conversion handler is further configured to apply an offset to the non-random pad prior to applying the representative cryptographic algorithm to the received data using the retrieved non-random pad.

13. The method of claim 8, in which the pad handler is further configured to receive configuration data for creating the non-random pad including receiving a list of pad creation rules, the identifier, an offset, and identification of sources of media files.

14. The method of claim 8, in which the security controller is configured to receive representative algorithms, offsets, and pad identifiers and to provide the representative algorithms, offsets, and pad identifiers to the pad handler, in which the pad handler is configured to provide the non-random pads, the offsets, and the representative algorithms to the conversion handler, wherein the conversion handler produces the output data by applying the offsets and the representative cryptographic algorithms to the received data using the non-random pad, and destroys the non-random pad used by the conversion handler.

15. A non-transitory computer-readable storage medium with an executable program stored thereon, wherein the program instructs one or more processors to perform the following steps:
receiving data;
retrieving an identifier for determining a non-random pad and a representative cryptographic algorithm;
retrieving the non-random pad associated with the identifier; and
applying the representative cryptographic algorithm to the received data using the retrieved non-random pad to generate output data.

16. The program instructing the one or more processors as recited in claim 15, in which the received data is raw data and in which the applying the representative cryptographic algorithm to the received data using the retrieved non-random pad further comprises the step of encrypting the received data by applying the representative algorithm to the non-random pad to produce a sequence of values that are distinct from the received data.

17. The program instructing the one or more processors as recited in claim 15, in which the received data is encrypted data and in which the applying the representative cryptographic algorithm to the received data using the retrieved non-random pad further comprises the step of decrypting the received data by applying the non-random pad to the encrypted data to produce raw data.

18. The program instructing the one or more processors as recited in claim 15, in which the retrieving the non-random pad further comprises acquiring media files and applying a set of rules determined by the identifier to create the non-random pad.

19. The program instructing the one or more processors as recited in claim 15 further comprising the steps of applying an offset to the non-random pad prior to applying the representative cryptographic algorithm to the received data using the retrieved non-random pad.

20. The program instructing the one or more processors as recited in claim 15 further comprises the step of receiving, by the pad handler, non-random pads based on the pad identifiers, providing the non-random pads, the offsets, and the representative algorithms, from the pad handler to a conversion handler, producing output data by applying the offsets and the representative cryptographic algorithms to the received data using the non-random pad, and destroying the non-random pad used by the conversion handler.
